(19) United States
(12) Patent Application Publication
(10) Pub. No.: US 2026/0217605 A1
(43) Pub. Date: Jul. 30, 2026

(54) CHAR-BASED BLOCK PAVERS AND BRICK VENEERS AND METHODS OF MAKING SAME

(71) Applicant: UNIVERSITY OF WYOMING, Laramie, WY (US)

(72) Inventors: Kam Weng NG, Laramie, WY (US); Hua YU, Laramie, WY (US); Chooi Kim LAU, Laramie, WY (US); Suraj PRASAD PANDEY, Laramie, WY (US)

(21) Appl. No.: 19/143,297

(22) PCT Filed: Jan. 17, 2024
(86) PCT No.: PCT/US2024/011836

§ 371 Date: Jun. 25, 2025

Related U.S. Application Data
(60) Provisional application No. 63/439,527, filed on Jan. 17, 2023.

(51) Int. Cl. C04B 18/06; C04B 18/14; C04B 40/00; C04B 40/02; C04B 41/48

(52) U.S. Cl. CPC C04B 18/06; C04B 18/146; C04B 40/0046; C04B 40/0263; C04B 41/483; C04B 2201/20; C04B 2201/50

(57) ABSTRACT

Embodiments of the present disclosure relate to pyrolysis char block pavers (PCBPs), pyrolysis char brick veneers (PCBVs), and methods of forming PCBPs and PCBVs. The PCBP and PCBV includes a composition having a dry mixture and a wet mixture. The dry mixture includes pyrolysis char (PC) and cement materials. The wet mixture includes water, silica fume (SF), and additives. The composition is about 20% to 40% of PC, about 20% to 60% cement materials, about 0.1% to 10% SF, and about 1% to 1.5% additives, by weight. The methods include mixing water and additives to form a wet mixture; mixing pyrolysis char (PC) and cement materials to form a dry mixture; mixing the wet mixture and the dry mixture to form a composition mixture; transferring the composition mixture to a mold; pre-pressing the composition mixture; curing the composition mixture to for a composition; demolding the composition; and curing the composition.

### BACKGROUND

### Field

Embodiments of the present disclosure generally relate to structural materials. In particular, the disclosure relates to pyrolysis char block pavers (PCBPs), pyrolysis char bricks veneers (PCBVs), and methods of fabricating PCBPs and PCBVs.

### Description of the Related Art

Coal currently serves an important role as an energy source. However, an increasing demand for renewable energy has reduced the production and consumption of coal in the United States of America (USA). Coal is carbon-rich, and its use in energy generation may affect atmospheric CO₂ levels. The air pollution and global environmental issues associated with the combustion of coal have limited the continuous application of coal in energy production. Specifically, according to the Bureau of Safety and Environmental Enforcement (BSEE), global warming results from a various greenhouse gas emissions is partly due to fossil fuel burning, such as the combustion of coal. Therefore, several studies are being conducted to create new non-energy and fuel opportunities for Wyoming coal.

Wyoming is rated as one or the major producers of coal in the USA. The Wyoming Powder River Basin (PRB) coal plays an important role in the Wyoming energy industry. However, renewable energy is slowly replacing the coal industry, causing the market price of coal to drop. Thus, to attract new investment through technological innovation and support coal mine operations, environmentally friendly methods to create new diversified coal products are needed. One concern is characterizing the eco-efficiency of char products, which includes life-cycle metrics. In addition, the worldwide demand for bricks is rising, and is currently producing about 1,391 billion units. However, eco-friendly bricks suffer from various setbacks when comparing performance metrics to conventional clay bricks.

Therefore, there is a need for improved bricks derived from coal and methods of fabrication thereof.

### SUMMARY

In one embodiment, a pyrolysis char brick (PCB) is disclosed. The PCB includes a composition. The composition includes a dry mixture and a wet mixture. The dry mixture includes pyrolysis char (PC) and cement materials. The wet mixture includes water, silica fume (SF); and additives. The composition is about 20% to about 40% of PC, about 20% to about 60% cement materials, about 0.1% to about 10% SF, and about 1% to about 1.5% additives, by weight.

In another embodiment, a pyrolysis char block paver (PCBP) is disclosed. The PCBP includes a composition. The composition includes a dry mixture and a wet mixture. The dry mixture includes pyrolysis char (PC) and cement materials. The wet mixture includes water, silica fume (SF), and additives. The composition is about 25% to about 35% of PC, about 20% to about 60% cement materials, about 0.1% to about 10% SF, and about 1% to about 1.5% additives, by weight.

In yet another embodiment, a method of forming a PCB is disclosed. The method includes mixing water and additives to form a wet mixture; mixing pyrolysis char (PC) and cement materials to form a dry mixture; mixing the wet mixture and the dry mixture to form a pyrolysis char brick (PCB) mixture; transferring the PCB mixture to a mold; pre-pressing the PCB mixture; initially curing the PCB mixture to for a PCB; demolding the PCB; and curing the PCB.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 illustrates a flow diagram of a method of forming a composition, according to embodiments of the disclosure.

FIG. 2A is a graph illustrating the densities of PCBs with a water/(PC+binder) mass ratios of 0.39, according to embodiments of the disclosure.

FIG. 2B is a graph illustrating PCB samples for water/(PC+binder) mass ratios of 0.45, according to embodiments of the disclosure.

FIG. 3A is a graph illustrating the compressive strengths of PCB samples for water/(PC+binder) mass ratios of 0.39, according to embodiments of the disclosure.

FIG. 3B is a graph illustrating the compressive strengths of PCB samples for water/(PC+binder) mass ratios of 0.45, according to embodiments of the disclosure.

FIG. 4 is a graph illustrating the densities of PCB samples with different additives, according to embodiments of the disclosure.

FIG. 5 is a graph illustrating the compressive strengths of PCB samples with different additives, according to embodiments of the disclosure.

FIG. 6A is a graph illustrating the water absorption percentage of PCB samples, according to embodiments of the disclosure.

FIG. 6B is a graph illustrating the water absorption saturation coefficient of PCB samples, according to embodiments of the disclosure.

FIG. 7A is a graph illustrating the heat flow of the PCB mixture samples with a w/c ratio of 0.58, according to embodiments of the disclosure.

FIG. 7B is a graph illustrating the cumulative heat of the PCB mixture samples with a w/c ratio of 0.58, according to embodiments of the disclosure.

FIG. 7C is a graph illustrating the heat flow of the PCB mixture samples with a w/c ratio of 0.68, according to embodiments of the disclosure.

FIG. 7D is a graph illustrating the cumulative heat of the PCB mixture samples with a w/c ratio of 0.68, according to embodiments of the disclosure.

FIG. 8A is a graph illustrating the thermogravimetric (TG) curve and differential thermal (DT) curve for PCB samples cured at 7 days, according to embodiments of the disclosure.

FIG. 8B is a graph of illustrating the thermogravimetric (TG) curve and differential thermal (DT) curve for PCB samples cured at 28 days, according to embodiments of the disclosure.

FIG. 9A is a scanning electron microscope (SEM) micrograph of a G1-2b sample.

FIG. 9B is a SEM micrograph of a G1-2b-AE sample, according to embodiments of the disclosure.

FIG. 9C is a SEM micrograph of a G1-2b-GO sample, according to embodiments of the disclosure.

FIG. 10 illustrates a graph of the compressive strength of the 30% PC trass/trass-lime PCBP samples, according to embodiments of the disclosure.

FIG. 11 illustrates a graph of the compressive strength of the fly ash-alkaline activator PCBPs, according to embodiments of the disclosure.

FIG. 12 illustrates a graph of the compressive strength of the 40% PC trass/trass-lime PCBPs, according to embodiments of the disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to structural materials. In particular, the disclosure relates to pyrolysis char block pavers (PCBPs), pyrolysis char bricks veneers (PCBVs), and methods of fabricating PCBPs and PCBVs. In one embodiment, pyrolysis char bricks (PCBs) are disclosed. In another embodiment, pyrolysis char block pavers (PCBPs) are disclosed. In other embodiments, pyrolysis char brick veneers (PCBVs) are disclosed. In yet another embodiment, a method of forming PCBs is disclosed.

The inventors have found new and improved methods of fabricating PCBPs and PCBVs and compositions for PCBPs and PCBVs from raw coal by mixing pyrolysis char (PC) with additives to replace sand and improve physical properties. Briefly, raw coal is thermo-chemically converted to produce PC, and the resulting PC is then converted to PC block pavers (PCBPs) or pyrolysis char brick veneers (PCBVs).

The desire for environmentally-friendly materials, energy savings, and reduced energy consumption in building materials can be addressed by the building materials described herein. Building materials made with PC have reduced density, increased strength, reduced thermal conductivity, and increased insulative properties when compared to conventional materials, such as clay bricks. These materials, through recycling/reuse and decreasing the amount of energy usage in fabrication, further lessens the environmental impact of the PCBs.

The use of headings is for the purposes of convenience and does not limit the scope of the present disclosure. Embodiments described herein can be combined with other embodiments.

As used herein, a “composition” can include component(s) of the composition, reaction product(s) of two or more components of the composition, a remainder balance of remaining starting component(s), or combinations thereof. Compositions of the present disclosure can be prepared by any suitable mixing process.

### Compositions

Embodiments of the present disclosure generally relate to structural materials. In particular, the disclosure relates to pyrolysis char block pavers (PCBPs), pyrolysis char bricks veneers (PCBVs), and methods of fabricating PCBPs and PCBVs.

A composition (e.g., a PCB, a PCBP, or a PCBV) includes a dry mixture and a wet mixture. The dry mixture includes PC, binder, and additives. The wet mixture includes water and additives. The binder may include cement materials and silica fume (SF). The PCBs may include about 20% to about 40% of PC, about 20% to about 60% cement materials, about 0.1% to about 10% SF, and about 1% to about 1.5% additives, by weight. The wet mixture and dry mixture may be mixed together to form a PCB mixture. The water to PC ratio in the PCB mixture is from about 0.5 to about 1.5. The water to (PC+binder) ratio is from about 0.3 to about 0.5. The PCB mixture, when cured, may become the PCBs.

The PCBs have a compressive strength from about 5 MPa to about 60 MPa, such as about 35 MPA to about 55 MPa for PCBs with additives. The density of the PCBs is from about 1.0 g/cm³ to about 2.0 g/cm³, such as about 1.3 g/cm³ to about 1.6 g/cm³. The compressive strength of the PCBs with additives is greater than that of a conventional clay brick (about 10 MPa to about 35 MPa), making the PCBs suitable for construction applications.

In some embodiments, the PCBs may be treated with a hydrophobic coating. The treated PCBs have a water absorption percentage of less than about 5%, such as less than about 3%. The treated PCBs further have a saturation coefficient from about 0.4 to about 1.6, such as about 0.5 to about 0.8. The water absorption percentage and saturation coefficient of treated PCBs was less than that of ASTM C62 Grade Moderate Weathering (MW) brick and ASTM C62 Grade Severe Weathering (SW) brick, making it suitable for use in sever and moderate weather conditions.

The additives may include trass, trass lime, alkaline activators, fly ash, superplasticizers (SPs), air entraining (AE) agents, algae, graphene oxide (GO), or combinations therein. The SF may be amorphous micronized white silicon dioxide pozzolan, a densified SF (e.g., Trinic R-E-D 105WS, Trinic R-E-D 106 μm, Trinic Pozz Plus, Trinic Z3-95, DMI NanoPozz 100-D), or an undensified SF (e.g., Riteks microfume 106 μm). The GO may be in powder form. The algae may be in liquid form. SP may include polycarboxylic ether polymer (such as BASF Melflux), a polycarboxylate ether, a sulfonated naphthalene formaldehyde, a sulfonated melamine formaldehyde, a lignosulfate, an acrylic polymer, or combinations thereof. The AE agents include acrylic cement modifiers (e.g., Akona liquid), natural wood resins, vinsol resins, synthetic detergents, animal and vegetable fats and oils, water-soluble synthetic organic compounds, alkyl benzene sulfonates, or a combination thereof.

The cement materials may include ordinary Portland Cement Type I, ordinary Portland Cement Type II are defined using ASTM C150/C150M (ASTM 2022). Standard sand is defined using ASTM C33/C33M (ASTM 2018).

The PC may include about 75% to about 85% fixed carbon, about 10% to about 20% ash, about 1% to about 3% moisture, and about 0.5% to about 1.5% volatile matter. The PC may be pyrolyzed at between about 800° C. and about 900° C.

In some embodiments, the PCB is a PC block paver (PCBP) having a PC content of from about 25% to about 35%, such as about 30%. The chemical components of PC include fixed carbon (about 80.05%), ash (about 12.93%), moisture (about 7.02%), and volatile matter (about 0.0%). The dimensions of the PCBPs conform to ASTM C936. The density of the PCBPs is about 1.4 g/cm³ to about 1.7 g/cm³.

The PCBPs have a compressive strength between about 30 MPa and about 60 MPa, such as about 50 MPa to about 60 MPa. The water absorption of the PCBP is about 4% to about 6%, such as about 4.95%. The PCBPs had an average mass gain of about 1% to about 5% after the freeze thaw test. The abrasion value of the PCBPs was about 2 mm to about 3 mm, such as about 2.25 mm. The abraded volume was about 9 cm³ to about 13 cm³, such as about 10 cm³ to about 12 cm³, such as about 11.2 cm³.

In some embodiments, the PCB is a PC brick veneer (PCBV) having a PC content of from about 25% to about 35%, such as about 40%. The chemical components of PC include fixed carbon (about 80.05%), ash (about 12.93%), moisture (about 7.02%), and volatile matter (about 0.0%). The density of the PCBVs is about 1.4 g/cm³ to about 1.7 g/cm³.

The PCBVs have a compressive strength has a 28-day curing compressive strength of greater than about 15 MPa, such as between 15 MPa and about 30 MPa. The water absorption of the PCBV is about 4% to about 6%, such as about 5.3%. The PCBVs had an average mass gain of about 1% to about 5% after the freeze thaw test. The PCBV has an average linear change of about 0.0066%. The PCBV has a bond shear strength of about 2 MPa to about 4 MPa.

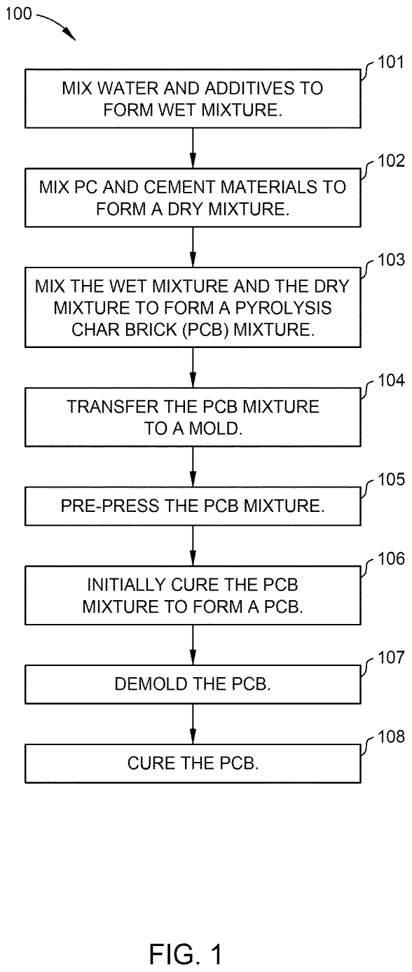

FIG. 1 illustrates a flow diagram of a method 100 of forming a composition (e.g., pyrolysis char bricks (PCBs), pyrolysis char brick veneer (PCBVs), pyrolysis char block pavers (PCBPs)). At operation 101, water and additives are mixed to form a wet mixture. The water and additive may be mixed for about 1 minute to about 10 minutes. The additives may include superplasticizer (SP), silica fume (SF), and graphene oxide (GO).

At operation 102, pyrolysis char (PC), cement materials, and sand are mixed to form a dry mixture. The PC, cement materials, and sand may be mixed for about 1 minutes to about 5 minutes.

At operation 103, the wet mixture is mixed with the dry mixture to form a composition mixture. The composition mixture includes about 20% to about 40% of PC, about 20% to about 60% cement materials, about 0.1% to about 10% SF, and about 1% to about 1.5% additives, by weight. The water to PC ratio in the composition mixture is from about 0.5 to about 1.5. The water to (PC+binder) ratio is from about 0.3 to about 0.5. The wet mixture and the dry mixture may be mixed using a laboratory mixer. The wet mixture and the dry mixture may be mixed for about 1 minute to about 10 minutes.

At operation 104, the composition mixture is transferred to molds. The molds may be metal molds in cubic or brick shape. At operation 105, the composition mixture is pre-pressed in the mold. The pre-pressing may occur at a pressing pressure of about 4 MPa to about 10 MPa for about 30 seconds to about 3 minutes.

At operation 106, the PCB mixture is initially cured to form a composition. The composition mixture may be covered with a plastic membrane to prevent moisture loss while being initially cured. After 24 hours of being covered in the plastic membrane, the composition mixture may be demolded before being initially cured. The composition mixture may be placed into a wet room with a constant temperature of about 20° C. to about 30° C. and a relative humidity of about 90% to about 100%. The composition mixture may be initially cured for about 5 to about 30 days. At operation 107, the compositions are demolded.

At operation 108, the compositions are transferred to the wet room with a constant temperature of 24° C. and relative humidity of 95% to further cure the PCBs. After reaching the designed curing time, e.g., 7, 14, 28 days, the density and compressive strength of PCBs are measured.

At optional operation 109, the compositions are dried in an oven. The oven dried compositions may have improved durability and reduced moisture absorption. The compositions may be oven-dried at 50° C. to about 70° C., such as about 60° C., for about 20 hours to about 30 hours, such as about 24 hours. The temperature is set to prevent crystalline water loss in hydration products (e.g., ettringite), which may weaken the bonding between PC and hydration products, and reducing the strength of the compositions.

At optional operation 110, the compositions are coated in a hydrophobic coating liquid. The compositions may be submerged in the hydrophobic coating liquid. During the submission, a vacuum pressure may be applied for about 20 hours to about 30 hours, such as about 24 hours. The vacuum pressure may enable the filling of pre-existed empty pores in PCBs with the hydrophobic coating liquid. The hydrophobic coating liquid may be a styrene acrylate material (e.g., BEHR PREMIUM Concrete & Masonry Protector & Waterproofer) with pH ranging from about 7 to about 10 and density of 0.99 g/cm³.

At optional operation 111, the compositions are air-dried. The compositions are air-dried for about 20 hours to about 30 hours, such as about 24 hours.

### Uses

Embodiments of the present disclosure generally relate to structural materials. In particular, the disclosure relates to pyrolysis char block pavers (PCBPs), pyrolysis char bricks veneers (PCBVs), and methods of fabricating PCBPs and PCBVs. Compositions described herein can also be used for various applications.

Illustrative, but non-limiting, applications include concrete masonry units such as cinder blocks, breezeblocks, hollow blocks, concrete blocks, construction blocks, Besser blocks, clinker blocks, paver blocks, among other concrete masonry units.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used by some experimental errors and deviations should be accounted for.

### EXAMPLES

### Test Methods

The compressive strength of the PCBs was measured using a Forney compression machine. The compressive strength of the PCBs in Experiment 1 was measured using ASTM C67. The compressive strength of PCBPs in Experiment 2 was measured using ASTM C410. The compressive strength of PCBPs in Experiment 3 was measured using ASTM 39.

The laboratory used for mixing is a stand mixer with a capacity of 7 quarts and maximum mixer speed of 900 rotations per minute.

Water absorption tests for the PCBs are performed in accordance with ASTM C67 (2021). The water absorption tests comprise 24 hours in cold water and 5 hours in boiling water. Freeze-thaw durability tests for Experiment 1 are performed in accordance with ASTM C67 (2021). Freeze-thaw durability tests for Experiment 2 are performed in accordance with ASTM standard C1645. Freeze-thaw durability tests for Experiment 3 are performed in accordance with ASTM standard C666.

The water absorption tests for the PCBPs in Experiment 1 are performed in accordance with ASTM C1645. The water absorption tests for the PCBPs in Experiment 2 are performed in accordance with ASTM standard C1645, where the entire half-block paver samples are submersed in the distilled water for 24 hours. The base of each PCBP sample is separated from the bottom of the container using plastic spacers during the test procedure. The desired water absorption is set in accordance with ASTM C936. The freeze thaw test was performed in accordance with ASTM C1645.

The scanning electron microscope (SEM) micrographs were made using FEI Quanta 250 SEM machine.

The abrasion test is performed in accordance with ASTM C418.

The thermogravimetric analysis and differential thermal analysis was performed using ASTM C1872. The thermogravimetric analysis was performed using TA Instruments Q500.

The dimensions of the PCBPs of Experiment 2 are 190×90×55 mm, as described in ASTM C936.

The linear drying shrinkage test was performed using ASTM C157.

The shear bond test was performed using ASTM C482.

### EXPERIMENTAL

### Experiment 1

The pyrolysis char bricks (PCBs) in this disclosure are fabricated from PC produced using Powder River Basin (PRB) coal in Wyoming. The coal is pyrolyzed at a temperature of about 850° C. The predominant chemical components of PC include fixed carbon (about 79.9%), ash (about 16%), moisture (about 2.9%), and volatile matter (about 1.2%). The PC bricks further include ordinary Portland cement type I & II referring to ASTM C150/C150M (ASTM 2022), standard sand referring to ASTM C33/C33M (ASTM 2018), silica fume (SF), black graphene oxide (GO) in powder form, algae (AG), superplasticizer (SP), and air entraining (AE) agent. The SF may be manufactured as RED 105 WS and may be amorphous micronized white silicon dioxide pozzolan. Black GO in powder form and AG in liquid form are manufactured at the University of Wyoming. However such materials are available from other commercial manufacturers. The SP is BASF Melflux 2651F in light yellowish powder form. The air entraining (AE) agent may be an Akona liquid air entraining admixture in liquid form with an amber color.

Table 1 shows a summary of the mixture design by weight percentage of the PCB samples. PCB samples having a water to (PC+binder) ratio of 0.39 were designated Group 1 (G1), while PCB samples having a water to (PC+binder) ratio of 0.45 were designated Group 2 (G2). The content of sand, SF, and water/cement ratio was varied throughout the various PCB samples. PC and SF in a fine powder may absorb a greater amount of water during the wet mixing process. The binder includes PC, cement materials, and SF. Water content may be reduced to improve the strength of the PCB. The additives (AE, AG, SF, and GO) may further improve the density and compressive strength of the PCBs.

TABLE 1
Summary of the Mixture Design (By Weight %) for PC Brick Samples.

| | | PC | Cement | Sand | SF | SP | water/(PC + | |
|---|---|---|---|---|---|---|---|---|
| Group | Specimen | content | content | content | content | content | binder) | w/c |
| ID | ID | (%) | (%) | (%) | (%) | (%) | ratio | ratio |
| G1 | G1-0 | 40 | 58.8 | 0 | 0 | 1.2 | 0.39 | 0.66 |
| | G1-1 | 40 | 56 | 0 | 2.8 | 1.2 | 0.39 | 0.66 |
| | G1-2 | 40 | 53.5 | 0 | 5.3 | 1.2 | 0.39 | 0.66 |
| | G1-3 | 40 | 49 | 0 | 9.8 | 1.2 | 0.39 | 0.66 |
| | G1-4 | 40 | 28 | 29.4 | 1.4 | 1.2 | 0.39 | 0.92 |
| | G1-5 | 40 | 26.7 | 29.4 | 2.7 | 1.2 | 0.39 | 0.92 |
| | G1-6 | 40 | 24.5 | 29.4 | 4.9 | 1.2 | 0.39 | 0.92 |
| | G1-7 | 40 | 18.7 | 39.2 | 0.9 | 1.2 | 0.39 | 1.19 |
| | G1-8 | 40 | 17.8 | 39.2 | 1.8 | 1.2 | 0.39 | 1.19 |
| | G1-9 | 40 | 16.3 | 39.2 | 3.3 | 1.2 | 0.39 | 1.19 |
| G2 | G2-0 | 40 | 58.8 | 0 | 0 | 1.2 | 0.45 | 0.76 |
| | G2-1 | 40 | 56 | 0 | 2.8 | 1.2 | 0.45 | 0.76 |
| | G2-2 | 40 | 53.5 | 0 | 5.3 | 1.2 | 0.45 | 0.76 |
| | G2-3 | 40 | 49 | 0 | 9.8 | 1.2 | 0.45 | 0.76 |
| | G2-4 | 40 | 28 | 29.4 | 1.4 | 1.2 | 0.45 | 1.06 |
| | G2-5 | 40 | 26.7 | 29.4 | 2.7 | 1.2 | 0.45 | 1.06 |
| | G2-6 | 40 | 24.5 | 29.4 | 4.9 | 1.2 | 0.45 | 1.06 |
| | G2-7 | 40 | 18.7 | 39.2 | 0.9 | 1.2 | 0.45 | 1.37 |
| | G2-8 | 40 | 17.8 | 39.2 | 1.8 | 1.2 | 0.45 | 1.37 |
| | G2-9 | 40 | 16.3 | 39.2 | 3.3 | 1.2 | 0.45 | 1.37 |

In one experiment, the PCB samples are prepared using the pre-pressing method. Initially, water and additives are weighed and fully mixed for about five minutes to form the wet mixture. Dry PC, cement materials, and sand are weighed and mixed for about three minutes to form the dry mixture. The wet mixture is then added and mixed with the dry mixture using a laboratory mixer for about five minutes. After wet mixing, the mixture is transferred to metal molds (in cubic or brick shape). Then, the wet mixture is pre-pressed with a pressure of about 7 MPa for about 1 minute. After molding, all specimens are covered with plastic membrane to prevent moisture loss for initial curing. After 24 hours, all specimens are demolded and transferred to the wet room with a constant temperature of about 24° C. and relative humidity of about 95%. After reaching the designed curing time, the density and compressive strength of PCB samples are measured. The PCB samples are cured for about 7 days, about 14 days, and about 28 days.

The PCB samples are treated to reduce moisture absorption. First, the PCB samples are oven-dried at about 60° C. for about 24 hours. The temperature is set at about 60° C. to prevent crystalline water loss in hydration products (e.g., ettringite), weakening of the bonding between PC and hydration products, and reduction in the strength performance of PCBs. The oven-dried specimens are submerged in a hydrophobic coating liquid, and a vacuum pressure is applied for about 24 hours to facilitate the filling of pre-existed empty pores in PCBs with the hydrophobic coating liquid. The hydrophobic coating liquid may be BEHR PREMIUM Concrete & Masonry Protector & Waterproofer with pH ranging from about 7 to about 10 and density of about 0.99 g/cm³. The vacuum-coated PCBs are air-dried for about 24 hours before testing.

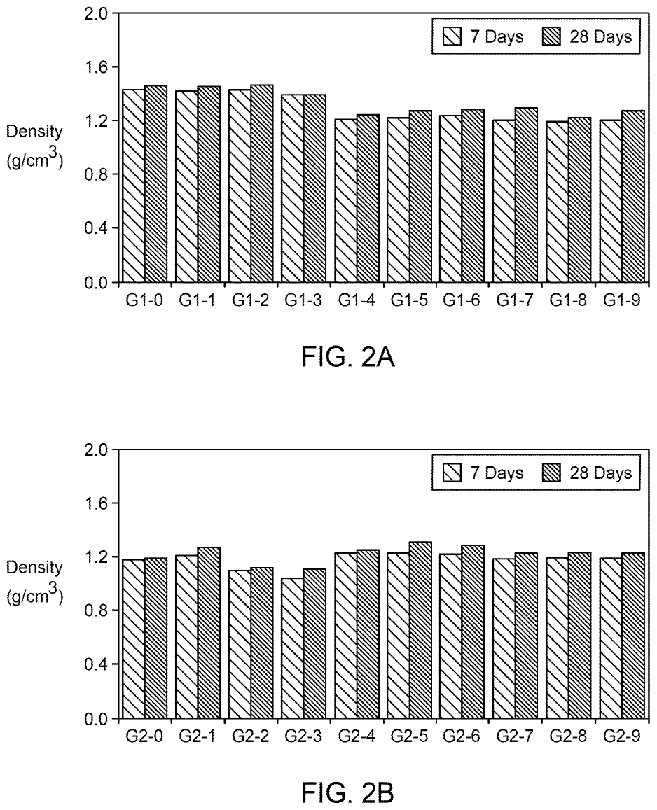

FIG. 2A is a graph illustrating the densities of PCBs with a water/(PC+binder) mass ratios of 0.39. FIG. 2B is a graph illustrating of PCBs for water/(PC+binder) mass ratios of 0.45. Increasing the curing time of the PCBs from 7 days to 28 days, regardless of water/(PC+binder) mass ratios or additions of sand and SF, may increase the density of the PCBs slightly (<8%). The increase may be due to newly formed hydration products in PCBs and water absorption from the wet room. The density of G1 PCBs ranges from about 1.19 g/cm³ to about 1.46 g/cm³. The density of G2 PCBs ranges from about 1.04 g/cm³ to about 1.31 g/cm³. The G1 PCBs may have a higher density due to the higher water content and lower content of solids in G2 specimens.

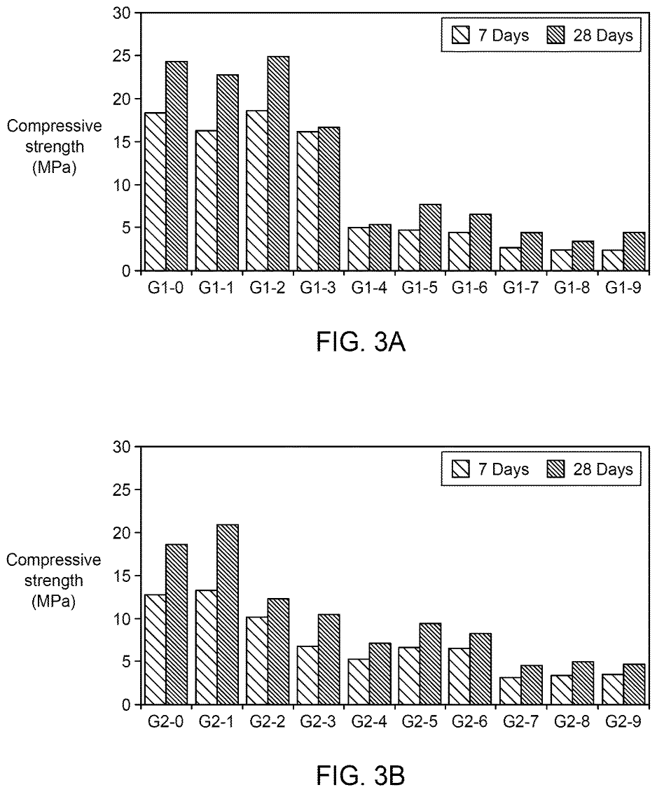

FIG. 3A is a graph illustrating the compressive strengths of PCB samples for water/(PC+binder) mass ratios of 0.39. FIG. 3B is a graph illustrating the compressive strengths of PCB samples for water/(PC+binder) mass ratios of 0.45. Increasing sand content to 39.2% decreases the compressive strength of specimens up to 82%. The higher sand content, which has non-binding characteristics, and lower cement material content may result in the lower compressive strength. The highest compressive strength of 25 MPa is observed in the G1-2 specimen. Increasing the water/(PC+binder) mass ratio may decrease the compressive strength. The compressive strength of G1-2 is only 2.4% higher than that of G1-0. The SF may benefit the PCB samples in terms of improved durability and elastic modulus.

Table 2 shows a summary of the mixture design of PCB samples with different additives. The mixture design of PCB sample G1-2b at a reduced w/c of 0.58 is comparable to that of cubic specimen G1-2. Using the mixture design of specimen G1-2b, the contents of AE, GO, and AG are set as 0.5% for PCB samples G1-2b-AE, G1-2b-GO, and G1-2b-AG, respectively. AE may improve workability of the PCB mixture, and can cause a reduction in the plastic viscosity of the PCB mixture. Increasing the AE content may cause a reduction in the w/c ratio, causing a lower w/c ratio for the G1-2b-AE PCB sample.

TABLE 2
Summary of the Mixture Design (By Weight %)
for PCB Samples with Different Additives

| | PC | Cement | SF | SP | AE | GO | AG | |
|---|---|---|---|---|---|---|---|---|
| Specimen | content | content | content | content | content | content | content | w/c |
| ID | (%) | (%) | (%) | (%) | (%) | (%) | (%) | ratio |
| G1-2b | 40 | 53.5 | 5.3 | 1.2 | 0 | 0 | 0 | 0.58 |
| G1-2b-AE | 40 | 53 | 5.3 | 1.2 | 0.5 | 0 | 0 | 0.57 |
| G1-2b-GO | 40 | 53.5 | 5.3 | 1.2 | 0 | 0.05 | 0 | 0.58 |
| G1-2b-ag | 40 | 53 | 5.3 | 1.2 | 0 | 0 | 0.5 | 0.54 |

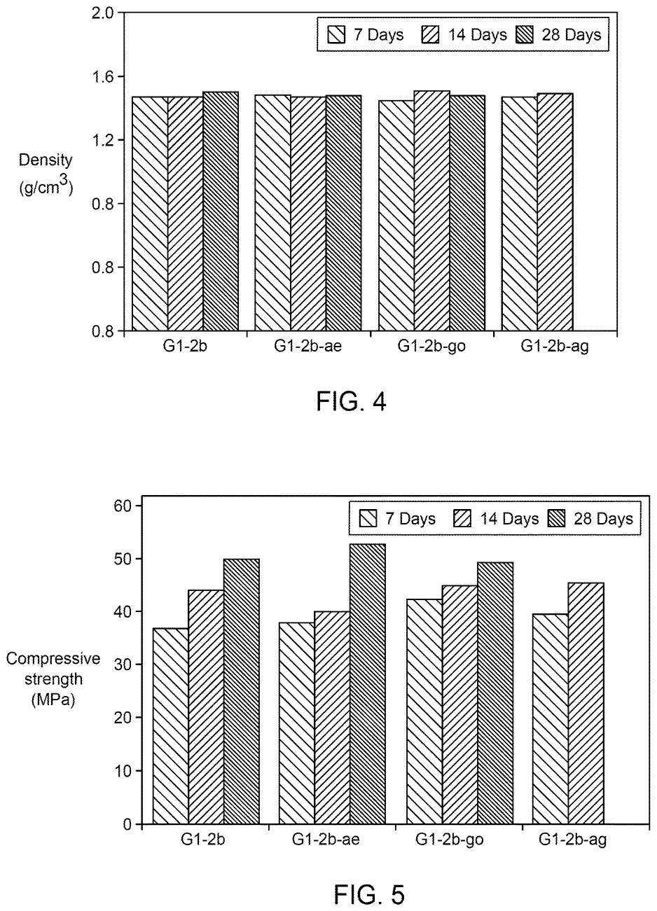

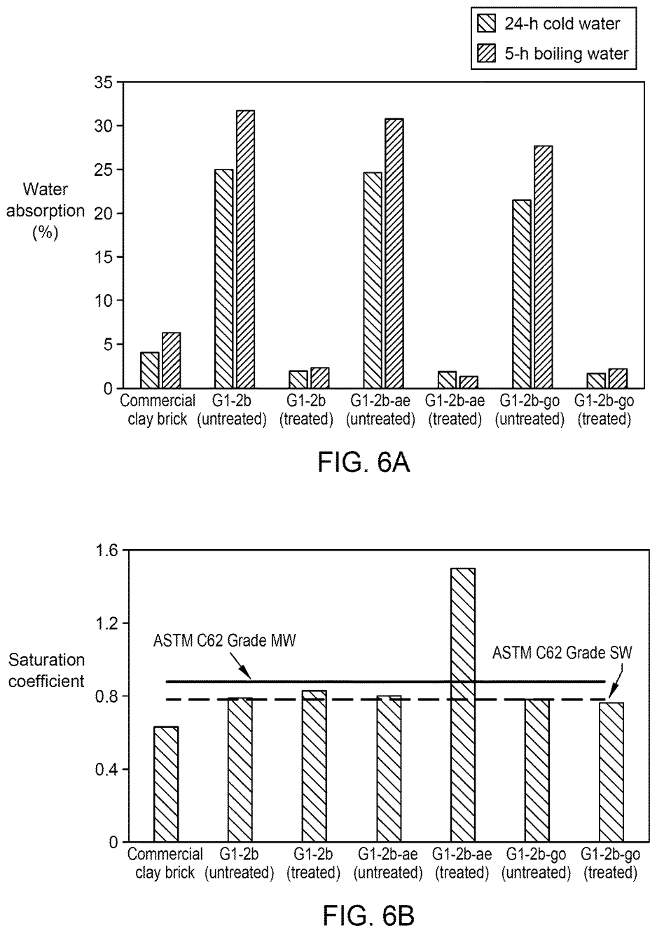

FIG. 4 is a graph illustrating the densities of PCB samples with different additives. FIG. 5 is a graph illustrating the compressive strengths of PCB samples with different additives. The densities of all PCB samples ranges between about 1.45 g/cm³ and 1.50 g/cm³. The effect of different additives on the density of PCBs may be limited. The compressive strength of conventional clay bricks (10-35 MPa) when tested in accordance with ASTM C62 (2017) and Indian Standard (IS) 1077 (1992) is between about 10 MPa and about 35 MPa. All PCB samples cured for 28 days exhibit compressive strength ≥49.2 MPa. From the perspective of strength development of all PCB samples, unlike the negative effect of AE in concrete reported in past studies, specimen G1-2b-AE exhibits the highest compressive strength of 52.5 MPa. At 7 days, the compressive strengths of G1-2b-GO and G1-2b-AG are 14.6% and 9.2% higher, respectively, than that of G1-2b. However, as the curing time increases to 28 days, the compressive strengths of G1-2b-GO and G1-2b-AG become comparable to that of G1-2b. Both GO and AG may be helpful in developing the early compressive strength while the strength enhancement from GO and AG may diminish with increasing curing time.

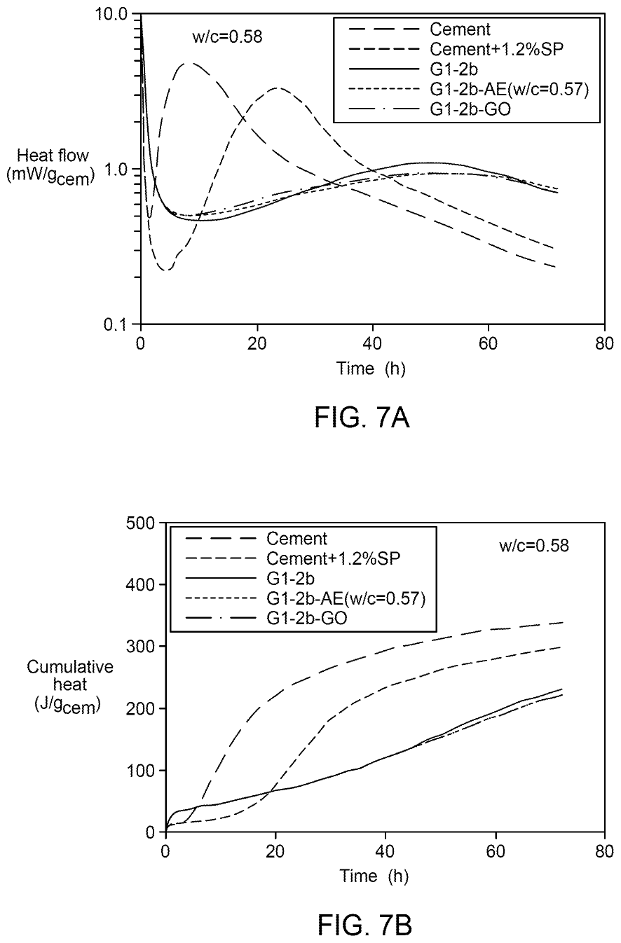

FIG. 6A is a graph illustrating the water absorption percentage of PCB samples. FIG. 6B is a graph illustrating the water absorption saturation coefficient of PCB samples. Table 3 is a summary of the water absorption results of PCB samples. For untreated PCBs, 24-h cold water absorptions range from about 21.5% to about 25%, which is higher than that of clay brick with 4% water absorption. The 5-h boiling water absorptions range from about 27.7% to about 31.7%, which is, on average, 75% higher than that of ASTM Grade SW brick and 36% higher than that of ASTM Grade MW brick. In contrast, the 5-h boiling water absorption of clay brick is only 6.3%, which is lower than the 17% for the ASTM Grade SW brick and 22% for the ASTM Grade MW brick. The saturation coefficient values are close to that of ASTM Grade SW brick.

For vacuum-treated PCB samples with hydrophobic coating liquid, regardless of different additives, both the 24-h cold water absorption and the 5-h boiling water absorption values are dramatically lower (>90%) than those of ASTM Grade SW brick, ASTM Grade MW brick and clay brick. For treated G1-2b-AE bricks, the saturation coefficient may be higher than one due to the 5-h boiling water absorption being relatively lower to the 24-h cold water absorption. No additional boiling water absorption and evaporation of pre-existing water occurred at high temperatures (e.g., about 92° C.) after the boiling test occurred.

TABLE 3
Summary of Water Absorption Results of PCB Samples.

| | 24-h cold water | 5-h boiling water | Saturation |
|---|---|---|---|
| Brick | absorption (%) | absorption (%) | coefficient |
| G1-2b (untreated) | 25 | 31.7 | 0.79 |
| G1-2b (treated) | 1.9 | 2.3 | 0.83 |
| G1-2b-ae (untreated) | 24.6 | 30.8 | 0.80 |
| G1-2b-ae (treated) | 1.8 | 1.2 | 1.50 |
| G1-2b-go (untreated) | 21.5 | 27.7 | 0.78 |
| G1-2b-go (treated) | 1.6 | 2.1 | 0.76 |
| ASTM C62 Grade SW | — | 17 | 0.78 |
| ASTM C62 Grade MW | — | 22 | 0.88 |
| Commercial clay brick | 4 | 6.3 | 0.63 |

Table 4 is a summary of the freeze-thaw (F-T) test results of the PCB samples. The vacuum treated G1-2b and G1-2b-AE experience more than 20 and 10 F-T cycles, respectively, without cracking. The PCBs performed better (10-20 cycles) than the commercial clay bricks, which cracked at 9 cycles.

TABLE 4
Summary of Freeze-Thaw Durability Test Results of PCB Samples

| | PC | | F-T cycles until |
|---|---|---|---|
| Brick | content (%) | Treatment | cracks observed |
| G1-2b | 40 | Treated | 20 |
| G1-2b-ae | 40 | Treated | 10 |
| Commercial clay brick | — | — | 9 |

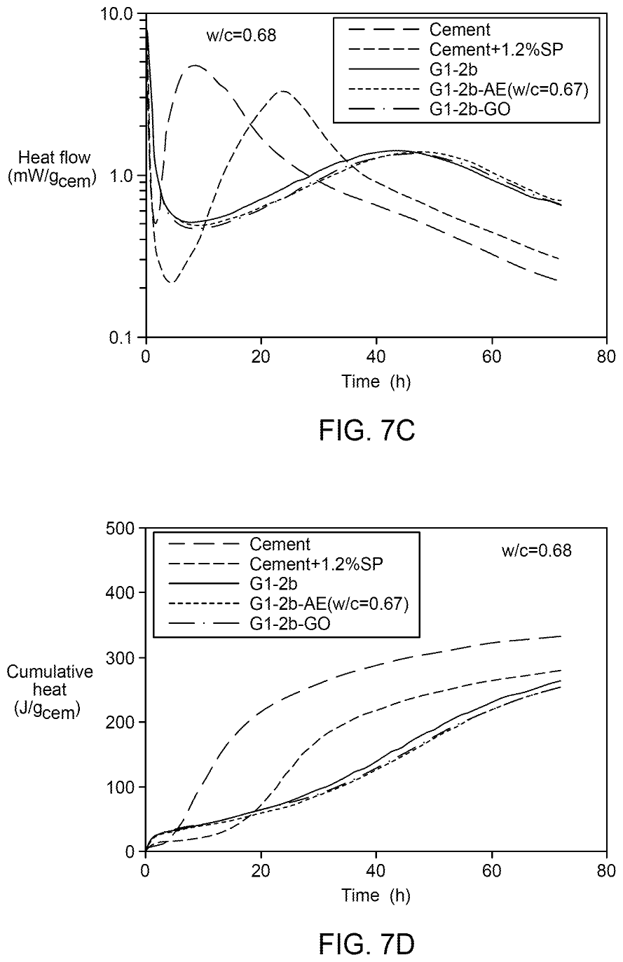

FIG. 7A is a graph illustrating the heat flow of the PCB mixture samples with a w/c ratio of 0.58. FIG. 7B is a graph illustrating the cumulative heat of the PCB mixture samples with a w/c ratio of 0.58. The PCB mixture samples include a 0.58 w/c unmodified cement sample (Cement), a 0.58 w/c PCB mixture with superplasticizers sample (Cement+1.2% SP), a 0.58 w/c G1-2b sample, a 0.57 w/c G1-2b-AE sample, and a 0.58 w/c G1-2b-GO sample. A first heat flow peak for the 0.58 w/c unmodified cement sample occurs at about 8.5 hours. This first heat flow peak may be due to the initial hydration of tricalcium silicate (C3S). The addition of 1.2% SP increases the first heat flow peak to about 23.8 hrs. This may be due to the polycarboxylate-based SP delaying the dissolution of C3S, thus delaying the formation of portlandite and CSH. Adding 40% PC delays the first heat flow peak to about 51 hours. This addition of PC may enhance the cement material hydration reaction due to the filler effect and nucleation caused by the electrostatic force between negatively charged PC and positively charged particles of the cement material. The delay may also be due to the large amount of free water absorbed by porous PC due to capillary force and the gradual release of absorbed water during cement material hydration.

The cumulative heat of the 0.58 w/c G1-2b is 69% lower than the 0.58 w/c unmodified cement sample and 39% lower than the 0.58 w/c PCB mixture with superplasticizers sample. As the mixing time increases, the cumulative heat of G1-2b is 32% lower than that of 0.58 w/c unmodified cement sample and 22% lower than that of the 0.58 w/c PCB mixture with superplasticizers sample.

FIG. 7C is a graph illustrating the heat flow of the PCB mixture samples with a w/c ratio of 0.68. FIG. 7D is a graph illustrating the cumulative heat of the PCB mixture samples with a w/c ratio of 0.68. The PCB mixture samples include a 0.68 w/c unmodified cement sample (Cement), a 0.68 w/c PCB mixture with superplasticizers sample (Cement+1.2% SP), a 0.58 w/c G1-2b sample, a 0.68 w/c G1-2b-AE sample, and a 0.58 w/c G1-2b-GO sample. The first heat flow peaks are comparable lower for the 0.68 w/c PCB mixture samples are lower than the 0.58 w/c PCB mixture samples. The first heat flow peak for the 0.68 w/c G1-2b, 0.68 w/c G1-2b-AE, and 0.68 w/c G1-2b-GO samples are between 43 hrs and 47 hrs. The first heat flow peak of the 0.68 w/c G1-2b, 0.68 w/c G1-2b-AE, and 0.68 w/c G1-2b-GO samples occurs about 15% faster than the 0.58 w/c G1-2b, 0.58 w/c G1-2b-AE, and 0.58 w/c G1-2b-GO samples. The higher w/c ration, therefore, may accelerate the hydration reaction in the PCB matrix at the early period (<72 hrs). This may be due to the higher amount of free water in the mixture.

For the 0.58 w/c G1-2b-AE, 0.58 w/c G1-2b-GO, 0.68 w/c G1-2b-AE, and 0.68 w/c G1-2b-GO, the peak heat flow and cumulative hydration heats are longer and higher, respectively, that the 0.58 w/c G1-2b and 0.68 w/c G1-2b samples. This may be due to the surface surfactants in AE partially obstruct the topochemical reaction of cement materials and water molecules, delaying cement material hydration. The nucleation effect may increase the heat release from the hydration acceleration, while the dilution of major compounds in the cement materials may decrease heat release. This may be due to the compensation of the nucleation effect of GO in the PC-cement material matrix by a large number of PC particles serving as nuclei during the cement material hydration and the dominant dilution effect of GO.

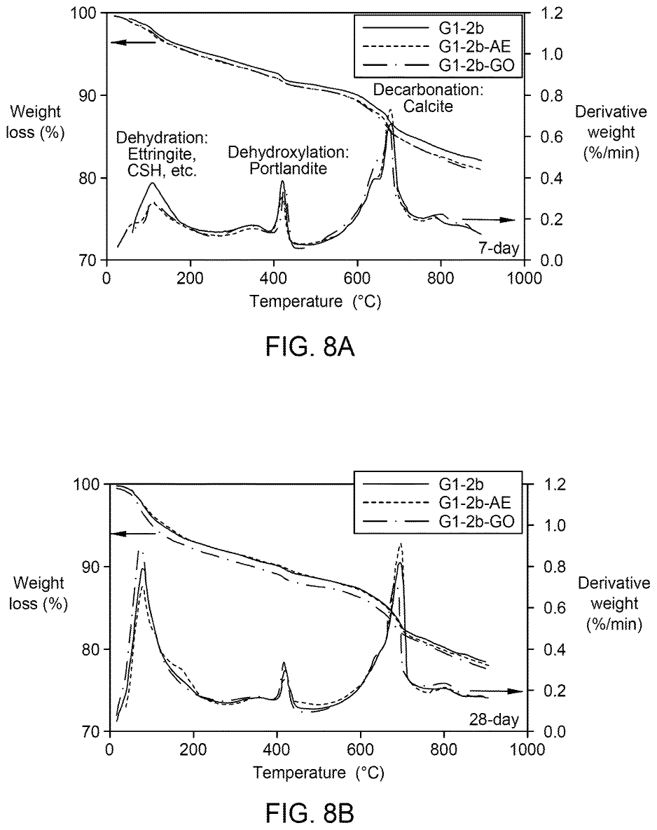

FIG. 8A is a graph illustrating the thermogravimetric (TG) curve and differential thermal (DT) curve for PCB samples cured at 7 days. FIG. 8B is a graph of illustrating the thermogravimetric (TG) curve and differential thermal (DT) curve for PCB samples cured at 28 days. The PCBs include G1-2b samples, G1-2b-AE samples, and G1-2b-GO samples. Three peaks may be observed for all PCB samples. The first peak may correspond to the dehydration of cement material hydration products at about 60° C. to about 350° C. The second peak may correspond to the dehydroxylation of portlandite at about 400° C. to about 500° C. The third peak may correspond to the decarbonation of calcite at about 600° C. to about 800° C. The largest peak of the DT curve is typically observed in dehydration temperatures for unmodified cement. For PCB samples cured at 7 days, the largest peak attains at the decarbonation temperatures. This may be due the absorbed water in the porous structures of PC reducing the available amount of free water in the mixture, which may hinder the formation of hydration products due to the delay in the hydration reaction. It may also be due to the higher air containing CO₂ trapped in the porous PC during the mixing process.

The contents of physically and chemically bound water, portlandite (CH), and calcite contents can be estimated using Equations (1)-(3):

$$Bound Water Content = \frac{Δ {W}_{( 60 ° C . - 350 ° C . )}}{{W}_{t}} \times 100 \qquad ( 1 )$$

$$CH Content = \frac{Δ {W}_{( 400 ° C . - 500 ° C . )} {M}_{C H}}{{W}_{t} {M}_{{H}_{2} O}} \times 100 \qquad ( 2 )$$

$$Calcite Content = \frac{Δ {W}_{( 600 ° C . - 800 ° C . )} {M}_{C a l c i t e}}{{W}_{t} {M}_{{CO}_{2}}} \times 100 \qquad ( 3 )$$

ΔW_{(60-350° C.)}, ΔW_{(400-500° C.)}, and ΔW_{(600-800° C.)} are the weight loss of the samples at 60-350° C., 400-500° C. and 600-800° C., respectively, from the TG results; Wₜ is the total weight of sample, M_{CH} is the molar mass of portlandite (74.09 g/mol), M_{calcite} is the molar mass of calcite (100.09 g/mol), M_{H}_{₂}_{O} is the molar mass of water (18.02 g/mol), and M_{CO}_{₂} is the molar mass of carbon dioxide (44.01 g/mol).

Table 5 is a summary of the compositions of PCB samples determined by the TG analysis. At 7 days, the bound water content of G1-2b-AE samples and G1-2b-GO samples are 1.7% and 3.4%, respectively, higher than that of G1-2b samples. The calcite contents of G1-2b-AE samples and G1-2b-GO samples are 5.4% and 7.5%, respectively, higher than that of G1-2b samples. The G1-2b-AE samples and G1-2b-GO samples may improve the early strength of the PCBs.

At 28 days, the calcite content of G1-2b-GO samples is 3% lower than that of the sample at 7 days. The G1-2b samples and G1-2b-AE samples do not exhibit this behavior. This may be due to the dissolution of calcite. The dissolution kinetics of calcite are related to pH, CO₂ pressure, and temperature. The G1-2b-GO samples may react with hydroxide ions in an alkaline solution and lose its oxygen-bearing groups, facilitating the dissolution of calcite with the reaction of Equation (4):

$${CaCO}_{3} + {H}^{+} = {Ca}^{2 +} + {HCO}_{3}^{-} \qquad ( 4 )$$

TABLE 5
Summary of the Compositions of PCB
Samples Determined by TG Analysis.

| | | G1-2b | | G1-2b-AE | | G1-2b-GO | |
|---|---|---|---|---|---|---|---|
| Temperature | | 7 | 28 | 7 | 28 | 7 | 28 |
| range | Content | days | days | days | days | days | days |
| 60-350° C. | Bound water | 5.8 | 8.2 | 5.9 | 8.0 | 6.0 | 8.5 |
| | (ettringite, | | | | | | |
| | CSH, etc.) (%) | | | | | | |
| 400-500° C. | Portlandite (%) | 6.0 | 6.2 | 5.9 | 6.5 | 5.7 | 6.1 |
| 600-800° C. | Calcite (%) | 14.6 | 15.9 | 15.4 | 16.3 | 15.7 | 15.2 |

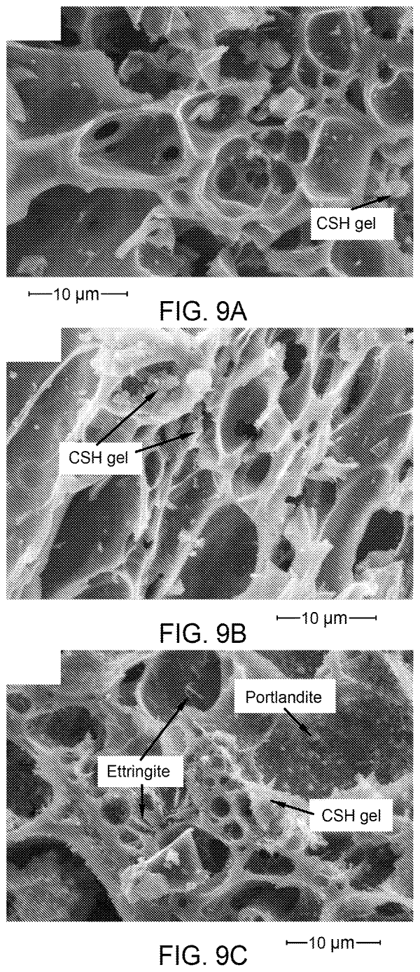

FIG. 9A is a scanning electron microscope (SEM) micrograph of a G1-2b sample. FIG. 9B is a SEM micrograph of a G1-2b-AE sample. FIG. 9C is a SEM micrograph of a G1-2b-GO sample. Few hydration products fill the porous PC in the G1-2b samples and G1-2b-AE samples. In contrast, the porous PC in G1-2b-GO samples are filled with hydration products. As the pyrolysis temperature increases, oxygen-containing functional groups on the PC surface decrease. The decrease in oxygen-containing functional groups (which may result in fewer hydrogen bonds to water molecules) of the PC pyrolyzed at 850° C. may lead to increased hydrophobicity. The hydrophobic surface of PC hinders the formation of hydration products on the surface or in the micropores of the PC. However, adding GO with the hydrophilic surface in a high pH environment (e.g., in hydrated cement materials) may form a GO film on the porous surface of the PC and may promote the filling of the micropores with hydration products.

Pyrolysis char block pavers (PCBPs) in this disclosure are fabricated from PC produced using Powder River Basin (PRB) coal in Wyoming. The coal is pyrolyzed at a temperature of about 850° C. The predominant chemical components of PC include fixed carbon (about 80.05%), ash (about 12.93%), moisture (about 7.02%), and volatile matter (about 0.0%). The dimensions of the PCBPs conform to ASTM C936. The density of the PCBPs is about 1.4 g/cm³ to about 1.7 g/cm³.

The PCBP further include ordinary Portland cement type I & II referring to ASTM C150/C150M (ASTM 2022), silica fume (SF), black graphene oxide (GO) in powder form, algae (AG), superplasticizer (SP), and air entraining (AE) agent. The SF is a NanoPozz100-D, i.e. an amorphous micronized grey silicon dioxide pozzolana. The SP is a BASF Melflux 2651F in the form of a light yellowish powder. The AE is an Akona liquid air entraining agent with an amber color, which can be used to introduce air bubbles and improve workability, durability, and resistance to freezing and thawing in various construction applications.

Table 6 summarizes the mix design for the PCBP samples. The dry mixture including PC and cement materials is combined with water and additive (e.g., SP and SF) to form the PCBP mixture. The dry mixture and wet mixture are mixed for about 3 minutes. The PCBP mixture is placed into molds in three equal layers. Each layer is compacted using a tamping rod for about 15 to about 20 blows. The tamping may increase the compaction and densification of the PCBP mixture in the mold. The compacted PCBP mixture is transferred to a pressing machine. The pressing machine further increases compaction and densification.

Following pressing, the PCBP mixture is cured for about 1 day in to the PCBP. The PCBP is demolded from the mold and placed in a humidifying chamber to cure. The humidifying chamber may provide moisture to the PCBP. The PCBP is cured in the humidifying chamber for about 28 days. The cured PCBP is then coated with hydrophobic liquid. The PCBP is dipped in the hydrophobic liquid for about 24 hours under suction. The immersion of the PCBP in the hydrophobic liquid may increase the water resistance properties of the PCBP, as well as increase the freeze thaw durability.

TABLE 6
Mix Design for PCBP Samples.

| PCBP | PC | Cement Material | | | | |
|---|---|---|---|---|---|---|
| Sample | content | Content | SF | SP | Additives | Note |
| C40-R | 40 | 53.50 | 5.30 | 1.2 | | R = Received |
| | | | | | | Char |
| C40-R-GF | 40 | 53.10 | 5.30 | 1.2 | 0.4% fiber | |
| C40-R-Na | 40 | 52.40 | 5.30 | 1.2 | 1.06% Na | |
| C40-R- | 40 | 52.10 | 5.30 | 1.2 | 1.06% Na, | |
| Na-AE | | | | | 0.3% AE | |
| C40-F-Na | 40 | 52.40 | 5.30 | 1.2 | 1.06% Na | F = Fine Char |
| C40-F- | 40 | 52.10 | 5.30 | 1.2 | 1.06% Na, | |
| Na-AE | | | | | 0.3% AE | |
| C40-F | 40 | 53.50 | 5.30 | 1.2 | | |
| S1-2F-FA | 40 | 37.55 | 5.30 | 1.2 | | S = Sand; |
| | | | | | | FA = Fine |
| | | | | | | Aggregate |
| S1-2FO- | 40 | 37.96 | 5.30 | 1.2 | | FO = Silica |
| FA | | | | | | Fume |
| C40-FO | 40 | 53.40 | 5.30 | 1.2 | | |
| C40-WR | 40 | 53.50 | 5.30 | 1.2 | | WR = Wet |
| | | | | | | Room |
| C30-FO | 30 | 63.50 | 5.30 | 1.2 | | |
| C35-FO | 35 | 58.50 | 5.30 | 1.2 | | |

The PCBP samples include a 40% PC, 53.5% cement materials, 1.2% SP, and 5.3% SF sample (C40-R), a 40% PC, 53.1% cement materials, 1.2% SP, 5.3% SF, and 0.4% fiber sample (C40-R-GF), a 40% PC, 52.4% cement materials, 1.2% SP, 5.3% SF, and 1.06% sodium (Na) sample (C40-R-Na), a 40% PC, 52.1% cement materials, 1.2% SP, 5.3% SF, 1.06% sodium (Na), and 0.3% AE sample (C40-R-Na-AE), a 40% PC, 53.1% cement materials, a 40% PC, 52.4% cement materials, 1.2% SP, 5.3% SF, and 1.06% sodium (Na) sample (C40-F-Na), a 40% PC, 52.1% cement materials, 1.2% SP, 5.3% SF, 1.06% sodium (Na), and 0.3% AE sample (C40-F-Na-AE), a 40% PC, 52.4% cement materials, a 40% fine PC, 53.5% cement materials, 1.2% SP, and 5.3% SF sample (C40-F), a 40% PC, 37.55% cement materials, 1.2% SP, and 5.3% SF sample (S1-2F-FA), a 40% PC, 37.96% cement materials, 1.2% SP, and 5.3% SF sample (S1-2FO-FA), a 40% PC, 53.5% cement materials, 1.2% SP, and 5.3% SF sample (C40-FO), a 40% PC, 53.5% cement materials, 1.2% SP, and 5.3% SF sample (C40-WR), a 30% PC, 63.5% cement materials, 1.2% SP, and 5.3% SF sample (C30-FO), and a 35% PC, 58.5% cement materials, 1.2% SP, and 5.3% SF sample (C40-R). Fine PC is PC in which 98% of the PC particles are less than 300 microns. The PCBP samples have a water to binder ratio of 0.53, except for the S1-2F-FA and S1-2FO-FA samples which have a water to binder ratio of 0.45.

Table 7 shows the compressive strength of the PCBP samples. The C40-R PCBP ample had a compressive strength of 35.43 MPa. The C40-F PCBP sample had a compressive strength of 35.55 MPa, and the C40-FO has a compressive strength of 38.77 MPa. Thus, between the two curing techniques, the wet curing approach may have a higher strength than the PCBPs cured in the humidifying chamber. The C35-FO and C30-FO samples have the highest compressive strength. The C35-FO had a compressive strength of 44.15 MPa and the C30-FO had a compressive stress of 57.46 MPa.

TABLE 7
Compressive Strength of the PCBP Samples.

| | Compressive strength (MPa) | | |
|---|---|---|---|
| Mix-design | 7-day | 14-day | 28-day |
| C40-R | 28.95 | 31.67 | 35.43 |
| C40-R-GF | 29.11 | 28.53 | 32.04 |
| C40-R-Na | 23.95 | 35.23 | 37.55 |
| C40-R-Na-AE | 24.95 | 32.43 | 33.61 |
| C40-F-Na | 26.35 | 34.53 | 35.76 |
| C40-F-Na-AE | 28.27 | 34.58 | 34.77 |
| C40-F | 31.10 | 33.55 | 35.55 |
| S1-2F-FA | 37.12 | 37.55 | 39.36 |
| S1-2FO-FA | 35.12 | 37.96 | 39.23 |
| C40-FO | 34.36 | 38.60 | 38.77 |
| C40-WR | 28.72 | 36.83 | 38.81 |
| C30-FO | 48.95 | 54.10 | 57.46 |
| C35-FO | 35.76 | 39.84 | 44.15 |

Table 8 shows the freeze thaw test results. The water absorption test were conducted on the C30-FO samples. A total of three half-block paver samples were tested. The water absorption of the C30-FO samples was about 4.95%.

TABLE 8
Results of the Freeze Thaw Test.

| Weight after 24 hrs of | Oven dry weight | Water |
|---|---|---|
| submersion in | following | absorption |
| distilled water (g) | water submersion (g) | (%) |
| 798.0 | 763.3 | 4.54 |
| 694.2 | 661.9 | 4.87 |
| 664.8 | 630.4 | 5.45 |

| | |
|---|---|
| Average | 4.95 |

The freeze thaw was performed to test the ability of the PCBPs to resist crack formation due to extreme cold weather. The freeze thaw test was conducted on three C30-FO samples. A total of 28 cycles were carried out on the PCBP samples. Following the cycles, the residue collected was separated using a filter paper and oven dried. The ratio of the weight of the residue collected to the total surface area results in the average mass loss of the samples. The PCBPs had an average mass loss of about 18.68 g/m², which is within the acceptable limit of 225 g/m² as per ASTM C1645.

Table 9 shows the abrasion test results. The abrasion test was performed to characterize the PCBPs ability to perform under high abrasive forces, such as moving vehicles. The abrasion test was conducted on two C30-FO samples. The abrasion test was performed on 8 areas of the PCBP as per ASTM C418. A steel plate having a circular perforation at its center was used to expose the testing areas. The abrasion value of the PCBPs was about 11.2 cm³.

TABLE 9
Abrasion Test Results.

| | | | Abraded | Equivalent | Average |
|---|---|---|---|---|---|
| Initial | Final | | volume per | abraded volume | thickness |
| mass | mass | Mass of | 51.6 cm² area | per 50 cm² area | loss |
| (g) | (g) | clay (g) | (cm³) | (cm³) | (mm) |
| 1463.20 | 1445.56 | 17.64 | 10.69 | 10.36 | 2.1 |
| 1606.55 | 1586.06 | 20.49 | 12.42 | 12.03 | 2.4 |

| | | |
|---|---|---|
| Average | 11.20 | 2.25 |

### Experiment 2

PCBPs are generally rectangular with a protrusion on each side. The protrusion is designed by a broader and enlarged top section which then gradually tapers down as it descends. The protrusions create an effective interlocking effect between the block pavers for facilitating the installation process. The interlocking effect helps in distributing load across the entire pavement surface thereby ensuring structural integrity and long-term performance of the pavement surfaces. The density of the block paver ranges from 1.4 g/cm³ to 1.7 g/cm³.

The PCBPs are comprised of PC, Portland cement, superplasticizers (SP), silica fumes (SF), fly ash (FA), trass (T), trass-lime (TL), and water. The pyrolysis char is an inert material obtained from the pyrolysis of coal and is incombustible. The trass and trass-lime are pozzolanic materials that consist mainly of reactive alumina (aluminum oxide) and silicic acid (silicon dioxide). These materials may increase the strength of the design mix.

Table 10 shows a summary of the particle size of PC. 100% of the PC particles pass through the 800 μm sieve, more than 82% of the PC particles pass through the 300 μm sieve, and more than 50% of the PC particles pass through the 75 μm sieve.

TABLE 10
Summary of the Particle Size of PC.

| Aperture size of sieve (μm) | Percentage passing (%) |
|---|---|
| 800 | 100 |
| 300 | 82.54 |
| 75 | 51.14 |

Table 11 shows a summary of the particle size of PC. 100% of particles pass through the 800 μm sieve, more than 99% of particles pass through the 300 μm sieve, and more than 87% of the particles pass through the 75 μm sieve.

TABLE 11
Summary of the Particle Size of Trass.

| Aperture size of sieve (μm) | Percentage passing (%) |
|---|---|
| 800 | 100 |
| 300 | 99.74 |
| 75 | 87.83 |

Table 12 shows a summary of the particle size of PC. 100% of particles pass through the 800 μm sieve, 100% of particles pass through the 300 μm sieve, and more than 50% of the particles pass through the 75 μm sieve.

TABLE 12
Summary of the Particle Size of Trass-Lime.

| Aperture size of sieve (μm) | Percentage passing (%) |
|---|---|
| 800 | 100 |
| 300 | 100 |
| 75 | 94.03 |

SP, SF, and air entraining (AE) agents are added as an. SP may increase the workability of the PCBPs, whereas SF and AE may increase the strength of the PCBPs. The SF may be a silica fume (NanoPozz100-D), i.e., amorphous micronized grey silicon dioxide pozzolana. The SP may be a BASF Melflux 2651F in the form of a light yellowish powder.

Table 13 shows a summary of the mixture designs for trass/trass-lime PCBP samples. A mix design composition for producing PCBPs (e.g., a control mix PCBP) is composed of 30% char, 63.4% cement, 1.2% SP, and 5.4% SF (C30-F-SF1). Mix designs incorporating trass and trass lime replace cement materials. The 30% PC samples include replacement amounts include 100% trass (T1-C30), 50% trass (T2-C30), 25% trass (T3-C30), 12.5% trass (T4-C30), and 6.25% trass (T5-C30), 100% trass lime (TL1-C30), 50% trass lime (TL2-C30), 25% trass lime TL3-C30), 12.5% trass lime (TL4-C30), and 6.25% trass lime (TL5-C30).

A mix design composition for producing PCBPs (e.g., a control mix PCBP) is composed of 40% char, 63.4% cement, 1.2% SP, and 5.4% SF (C40-F-SF1). Mix designs incorporating trass and trass lime replace cement materials. The 40% PC samples include replacement amounts include 100% trass (T1-C40), 50% trass (T2-C40), 25% trass (T-C40), 12.5% trass (T4-C40), and 6.25% trass (T5-C40), 100% trass lime (TL1-C40), 50% trass lime (TL2-C40), 25% trass lime (TL3-C40), 12.5% trass lime (TL4-C40), and 6.25% trass lime (TL5-C40).

TABLE 13
Summary of the Mixture Design for
Trass/Trass-Lime PCBP Samples.

| | PC | Cement | Trass/Trass- | SF | SP | |
|---|---|---|---|---|---|---|
| Sample | content | content | lime | content | content | w/b |
| ID | (%) | (%) | content (%) | (%) | (%) | ratio |
| C30-F- | 30 | 63.40 | 0 | 5.4 | 1.2 | 0.40 |
| SF1 | | | | | | |
| T/TL1- | 30 | 0 | 63.40 | 5.4 | 1.2 | 0.40 |
| C30 | | | | | | |
| T/TL2- | 30 | 31.70 | 31.70 | 5.4 | 1.2 | 0.40 |
| C30 | | | | | | |
| T/TL3- | 30 | 47.60 | 15.90 | 5.4 | 1.2 | 0.37 |
| C30 | | | | | | |
| T/TL4- | 30 | 55.50 | 7.90 | 5.4 | 1.2 | 0.37 |
| C30 | | | | | | |
| T/TL5- | 30 | 59.45 | 3.95 | 5.4 | 1.2 | 0.37 |
| C30 | | | | | | |
| C40-F- | 40 | 63.40 | 0 | 5.4 | 1.2 | 0.53 |
| SF1 | | | | | | |
| T/TL1- | 40 | 0 | 63.40 | 5.4 | 1.2 | 0.50 |
| C40 | | | | | | |
| T/TL2- | 40 | 31.70 | 31.70 | 5.4 | 1.2 | 0.50 |
| C40 | | | | | | |
| T/TL3- | 40 | 47.60 | 15.90 | 5.4 | 1.2 | 0.50 |
| C40 | | | | | | |
| T/TL4- | 40 | 55.50 | 7.90 | 5.4 | 1.2 | 0.50 |
| C40 | | | | | | |
| T/TL5- | 40 | 59.45 | 3.95 | 5.4 | 1.2 | 0.50 |
| C40 | | | | | | |

Table 14 shows a summary of the mixture designs for fly ash-alkaline activator PCBP samples. A mix design composition for producing PCBPs (e.g., a control mix PCBP) is composed of 40% of char, 53.5% cement, 1.2% SP, and 5.3% SF (C40-F-SF1). The cement materials are replaced by fly ash in the PCBPs. In one sample, 10% of the cement material is replaced with fly ash (C40-FA-10). Alkali activators are added to accelerate the strength development of the fly ash samples. The alkali activators include Ca(OH)₂, CaO, and NaOH. The fly ash-alkali activator samples include 0.5% Ca(OH)₂ (C40-FA-10-Ca(OH)₂-0.5), 1% Ca(OH)₂ (C40-FA-10-Ca(OH)₂-1.0), and 2% Ca(OH)₂ (C40-FA-10-Ca(OH)₂-2.0), 0.5% CaO (C40-FA-10-CaO-0.5), 1% CaO (C40-FA-10-CaO-1.0), and 2% CaO (C40-FA-10-CaO-2.0), 0.5% NaOH (C40-FA-10-NaOH-0.5), 1% NaOH (C40-FA-10-NaOH-1.0), and 2% NaOH (C40-FA-10-NaOH-2.0).

TABLE 14
Summary of the Mixture Design for Fly Ash PCBP Samples.

| | PC | Cement | SF | SP | Fly ash | Alkali | |
|---|---|---|---|---|---|---|---|
| | content | content | content | content | content | content | w/b |
| Sample ID | (%) | (%) | (%) | (%) | (%) | (%) | ratio |
| C40-F-SF1 | 40 | 53.50 | 5.3 | 1.2 | 0 | 0 | 0.53 |
| C40-FA-10 | 40 | 48.15 | 5.3 | 1.2 | 5.35 | 0 | 0.53 |
| C40-FA-10- | 40 | 47.70 | 5.3 | 1.2 | 5.30 | 0.5 | 0.53 |
| Ca(OH)₂-0.5 | | | | | | | |
| C40-FA-10- | 40 | 47.25 | 5.3 | 1.2 | 5.25 | 1 | 0.53 |
| Ca(OH)₂-1.0 | | | | | | | |
| C40-FA-10- | 40 | 46.35 | 5.3 | 1.2 | 5.15 | 2 | 0.53 |
| Ca(OH)₂-2.0 | | | | | | | |
| C40-FA-10-CaO- | 40 | 47.70 | 5.3 | 1.2 | 5.30 | 0.5 | 0.53 |
| 0.5 | | | | | | | |
| C40-FA-10-CaO- | 40 | 47.25 | 5.3 | 1.2 | 5.25 | 1 | 0.53 |
| 1.0 | | | | | | | |
| C40-FA-10-CaO- | 40 | 46.35 | 5.3 | 1.2 | 5.15 | 2 | 0.53 |
| 2.0 | | | | | | | |
| C40-FA-10- | 40 | 47.70 | 5.3 | 1.2 | 5.30 | 0.5 | 0.53 |
| NaOH-0.5 | | | | | | | |
| C40-FA-10- | 40 | 47.25 | 5.3 | 1.2 | 5.25 | 1 | 0.53 |
| NaOH-1.0 | | | | | | | |
| C40-FA-10- | 40 | 46.35 | 5.3 | 1.2 | 5.15 | 2 | 0.53 |
| NaOH-2.0 | | | | | | | |

Water is mixed with SP and SF according to Table 13 to form a wet mixture. The wet mixture is added to a dry mixture of PC and cement materials for three to five minutes to obtain the PCBP mixture. The PCBP mixture is placed in prepared molds in three equal layers. Each layer is compacted using a tamping road for around 15 to 20 blows. This tamping ensures the proper compaction and densification of the mixes in the molds. The compacted PCBP mixture in the mold is transferred to a machine where the mix is pressed under 7 MPa pressure for one minute. This pressing action further enhances the compaction and densification process.

Following the pressing stage, the PCBP mixture is cured within the mold for one day to form the PCBP. After one day, the PCBP is demolded from the steel mold. The demolded PCBP is then placed in the humidifying chamber for further curing. This humidifying chamber provides an amount of moisture, along with other conditions, for the PCBP to cure continuously for 28 days.

The PCBP after 28 days of curing is dipped into a hydrophobic liquid for 24 hours under suction pressure before test analysis. This immersion process aims to increase the water-resisting property of PCBPs and the freeze-thaw durability.

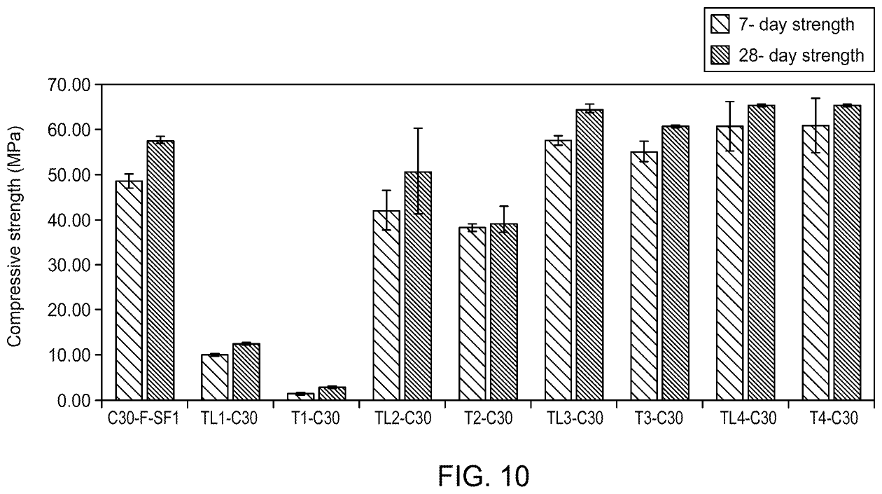

FIG. 10 illustrates a graph of the compressive strength of the 30% PC trass/trass-lime PCBP samples. The control mix PCBP C30-F-SF1 showed the 7-day and 28-day compressive strength values as 49.0 MPa and 57.5 MPa. These values meet the minimum compressive requirement of 55 MPa for block pavers as given by ASTM standard C936. The highest compressive strength trass/trass lime PCBPs were the 12.5% samples (T/TL4-C30). The 7-day and 28-day compressive strengths of the T4-C30 samples were 61.59 MPa 65.62 MPa, respectively. The 7-day and 28-day compressive strengths of the TL4-C30 samples were 61.28 MPa and 65.71 MPa, respectively. For the T3-C30, the 7-day and 28-day compressive strengths were 54.55 MPa and 60.89 MPa, respectively. The 7-day and 28-day compressive strengths of the TL3-C30 samples were 58.12 MPa 64.53 MPa, respectively. The 7-day and 28-day compressive strengths of the T2-C30 samples were 37.23 MPa and 38.33 MPa, respectively. The 7-day and 28-day compressive strengths of the TL2-C30 samples were 43.15 MPa and 50.76 MPa, respectively. The 7-day and 28-day compressive strengths of the T1-C30 samples were 1.33 MPa and 2.31 MPa, respectively. The 7-day and 28-day compressive strengths of the TL1-C30 samples were 10.40 MPa and 12.21 MPa. Generally, as the amount of trass/trass lime decreases, the compressive strength of the PCBP increases. This may indicate that, while the replacement of portions of the cement materials with trass/trass lime may enable increases in the compressive strength of brick pavers, the replacement of large amounts (e.g., greater than about 25%) of the cement materials with trass/trass lime may compromise the strength of the PCBPs.

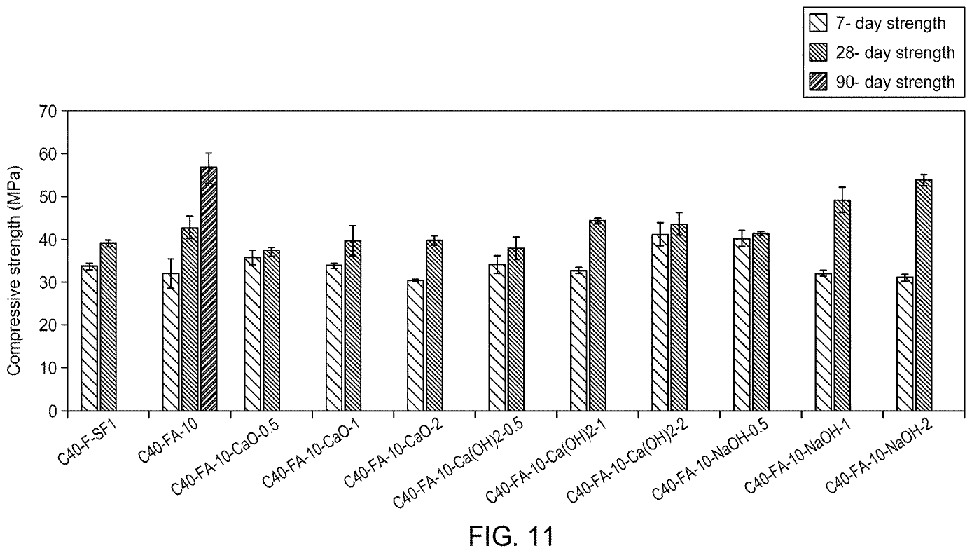

FIG. 11 illustrates a graph of the compressive strength of the fly ash-alkaline activator PCBPs. The control mix PCBP C40-F-SF1 showed the 7-day and 28-day compressive strength values as 34.36 MPa and 38.77 MPa, respectively. The 10% fly ash sample C40-F-SF1 showed the 7-day, 28-day, and 90-day compressive strengths as 31.6 MPa, 42.48 MPa, and 56.63 MPa, respectively. The C40-FA-10-NaOH-2.0 samples had 7-day and 28-day compressive strengths of 31.8 MPa and 55.06 MPa, respectively. The C40-FA-10-NaOH-2.0 outperformed the C40-FA-10-NaOH-1.0 and C40-FA-10-NaOH-0.5 samples, as well as with other alkali activators CaO and Ca(OH)₂. The C40-FA-10-NaOH-0.5 samples had 7-day and 28-day compressive strengths of 41.08 MPa, 42.47 MPa, respectively. The C40-FA-10-NaOH-1.0 samples had 7-day and 28-day compressive strengths of 32.8 MPa and 50.18 MPa, respectively. The C40-FA-10-Ca (OH) 2-1.0 samples had a 7-day and 28-day strengths of 33.6 MPa and 45.38 MPa, respectively, thereby outperforming the C40-FA-10-Ca (OH) 2-0.5 samples and C40-FA-10-Ca (OH) 2-2.0 samples. The C40-FA-10-Ca (OH) 2-0.5 samples had 7-day and 28-day compressive strengths of 34.88 MPa, 38.83 MPa, respectively. The C40-FA-10-Ca (OH) 2-2.0 samples had 7-day and 28-day compressive strengths of 42.22 MPa and 44.62 MPa, respectively. Similarly, the C40-FA-10-CaO-1.0 samples outperformed the C40-FA-10-CaO-0.5 samples and C40-FA-10-CaO-2.0 samples. The C40-FA-10-CaO-1.0 samples had 7-day and 28-day compressive strengths of 34.64 MPa and 40.70 MPa, respectively. Meanwhile C40-FA-10-CaO-0.5 samples had 7-day and 28-day compressive strengths of 36.70 MPa, 38.10 MPa, respectively, and the C40-FA-10-CaO-2.0 samples had 7-day and 28-day compressive strengths of 31.29 MPa and 40.66 MPa, respectively. The alkali activator, particularly sodium hydroxide (NaOH) at a concentration constituting 2% of the overall dry mix, demonstrates the an enhancement in 28-day strength. The C40-FA-10-NaOH-2.0 samples had a higher compressive strength than the other alkali activators such as calcium oxide (CaO) and calcium hydroxide (Ca(OH)₂).

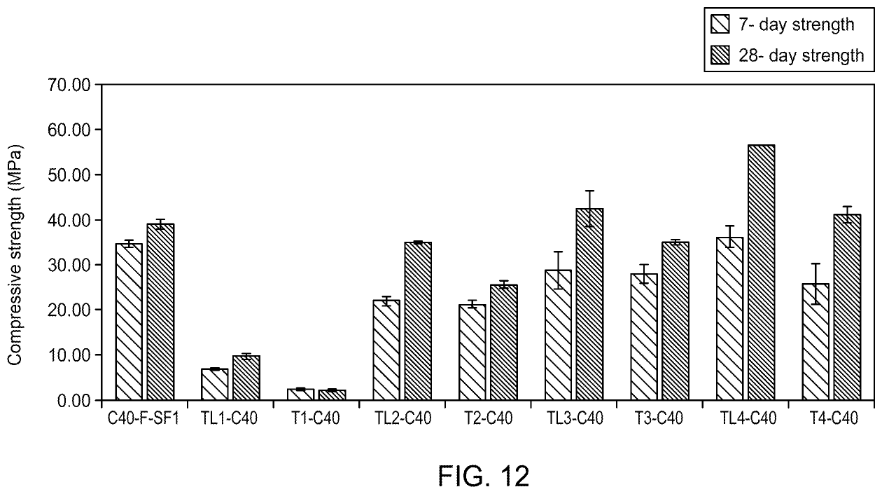

FIG. 12 illustrates a graph of the compressive strength of the 40% PC trass/trass-lime PCBPs. The 7-day and 28-day compressive strengths of trass and trass lime at 12.5% replacement ratio (e.g., the T/TL4-C40) showed the highest compressive strength results. The T4-C40 samples had 7-day and 28-day compressive strengths of 25.22 MPa and 40.95 MPa, respectively. TL4-C40 samples had 7-day and 28-day compressive strengths of 35.84 MPa and 56.48 MPa, respectively. The T3-C40 samples had 7-day and 28-day compressive strengths of 27.46 MPa, 34.59 MPa, respectively. The TL3-C40 samples had 7-day and 28-day compressive strengths of 28.36 MPa and 42.17 MPa, respectively. The 7-day and 28-day compressive strengths of the T2-C40 samples were 20.77 MPa and 25.12 MPa, respectively, while the TL2-C40 samples had a 7-day and 28-day compressive strength of 21.36 MPa and 34.64 MPa, respectively. The T1-C40 samples had a 7-day and 28-day compressive strengths of 1.43 MPa and 2.25 MPa, respectively, while the TL1-C40 samples had a 7-day and 28-day compressive strengths of 5.98 MPa and 8.90 MPa, respectively. As with the 30% PC trass/trass lime PCBP samples, while the replacement of portions of the cement materials with trass/trass lime may enable increases in the compressive strength of block pavers, the replacement of large amounts (e.g., greater than about 25%) of the cement materials with trass/trass lime may compromise the strength of the PCBPs.

Table 16 shows a summary of the water absorption test results for the control mix PCBP sample C30-F-SF1. A total of three half-block paver samples are prepared and tested. The control mix PCBP sample C30-F-SF1 had a water absorption rate of 4.95%, which is within the permissible range.

TABLE 16
Summary of the Water Absorption Test Results.

| Weight after 24 hrs of | Oven dry weight | Water |
|---|---|---|
| submersion in | following water | absorption |
| distilled water (g) | submersion (g) | % |
| 798.0 | 763.3 | 4.54 |
| 694.2 | 661.9 | 4.87 |
| 664.8 | 630.4 | 5.45 |

| | |
|---|---|
| Average | 4.95 |

The freeze-thaw test measures the ability of PCBP samples to resist crack formation due to extreme cold weather. The freeze-thaw test was conducted under Zone 3 conditions according to ASTM C936. Zone 3 tests the freeze-thaw at a freezing temperature of −12° C. for 16 hours and a thawing temperature of a minimum of 5° C. for the last one hour of thawing out of eight hours. A total of 28 cycles are carried out on three samples. Following 28 cycles, the residue collected is separated using filter paper and then oven dried. The ratio of the weight of residue collected to the total surface area of samples gives the average mass loss of samples. The test results showed an average mass loss of 18.68 g/m², which is within the permissible range of 225 g/m².

Table 17 shows a summary of the abrasion test results for the control mix PCBP sample C30-F-SF1. The abrasion test measures the ability of the PCBP samples to perform under the high abrasive forces of moving vehicles. A total of two PCBP samples were tested. Compressed air and abrasive material are injected onto eight PCBP sample surfaces for one minute on each spot. The abraded volume is measured, and the thickness loss is calculated by dividing the measured abraded volume by the sum of the cross-sectional area of all eight spots. This thickness value gives the abrasion resistance characteristic of the block paver. The average abrasion value is found to be 2.25.

TABLE 17
Summary of the Abrasion Test Results.

| | | | Abraded | Equivalent | |
|---|---|---|---|---|---|
| | | | volume | abraded | Average |
| Initial | Final | | per 51.6 | volume per 50 | thickness |
| mass | mass | Mass of | cm² area | cm² area | loss |
| (g) | (g) | clay (g) | (cm³) | (cm³) | (mm) |
| 1463.20 | 1445.56 | 17.64 | 10.69 | 10.36 | 2.10 |
| 1606.55 | 1586.06 | 20.49 | 12.42 | 12.03 | 2.40 |

| | | |
|---|---|---|
| Average | 11.20 | 2.25 |

In summary, the control mix PCBP C30-F-SF1 had a compressive strength of 57.5 MPa. By adding trass and trass lime as a replacement to cement materials at a ratio of 12.5% with cement showed increased compressive strengths of 65.62 MPa and 65.71 MPa for trass and trass lime, respectively. Similarly, incorporating fly ash at a 10% cement replacement ratio in the C40-F-SF1 mix design showed 90-day compressive strength as 56.63 MPa. Meanwhile, fly ash activated using NaOH at 2% (C40-FA-10-NaOH-2.0) increased the strength to 55.06 MPa at 28-day. Moreover, the use of trass lime at a cement replacement ratio of 12.5% (T/TL4-C40) showed an increased compressive strength of 56.48 MPa. All these mix designs had compressive strengths above 55 MPa, satisfying the compressive strength requirements of ASTM standard C936. The mix design C30-F-SF1 has also successfully satisfied stringent assessments such as freeze-thaw durability tests, water absorption tests, and abrasion tests. Thus, the PCBPs have adequate compressive strength, good freeze-thaw durability, low abrasion value index, and minimal water absorption.

### Experiment 3

A PC brick veneer (PCBVs) can be customized into various forms depending on the casting mold type employed. Square-shaped and rectangular-shaped PCBV samples were with dimensions of 150×150×22 mm and 189×90×25 mm. The flexibility of production allows the developers to provide PCBVs that enhance the aesthetic appeal of different architectural styles. The density of the stone veneer is about 1.5 g/cm³. To ensure the quality of the stone veneers, the testing requirements as provided in ASTM C1670 are strictly carried out.

The materials used for developing the char-based stone veneer include pyrolysis char (PC), Portland cement, superplasticizers (SP), silica fumes (SF), and water. Pyrolysis char is an inert material obtained from coal pyrolysis and is incombustible. Cement materials are known for strengthening and binding inert materials together to provide higher stability. Similarly, SP, SF, and AE are added as an admixture to improve the performance of the mixture. In addition, SP helps in increasing workability, whereas SF helps to increase strength.

The PC particle composition is as shown in Table 10. 100% of particles pass through the 800 μm sieve, more than 82% of particles pass through the 300 μm sieve, and more than 50% of the particles pass through the 75 μm sieve.

The PCBVs are comprised of PC, Portland cement, superplasticizers (SP), silica fumes (SF), fly ash (FA), trass (T), trass-lime (TL), and water. The pyrolysis char is an inert material obtained from the pyrolysis of coal and is incombustible. The trass and trass-lime are pozzolanic materials that consist mainly of reactive alumina (aluminum oxide) and silicic acid (silicon dioxide). These materials may increase the strength of the design mix.

Table 18 shows a summary of the mixture design for PCBV samples. Stone veneers are designed based on the control mix PCBV (SV-C40-SF1). The control mix PCBV contains 40% char, 53.5% cement, 1.2% superplasticizer (SP), and 5.3% silica fume (SF). Cylindrical samples of dimensions 50 mm×100 mm are prepared to test the compressive strength. PCBV samples are varied by compacting pressure and water to cement ratio (w/c). The PCBV samples includes a PCBV packed at 500 kPA with w/c of 0.53 (SV-C40-SF11), a PCBV packed at 250 kPA with w/c of 0.53 (SV-C40-SF12), a PCBV packed at 500 kPA with w/c of 0.53 (SV-C40-SF1³), and a PCBV packed at 0 kPA with w/c of 0.7 (SV-C40-SF1⁴).

TABLE 18
Summary of the Mixture Design for PCBV Samples.

| | PC | Cement | | | Water to | Compaction | |
|---|---|---|---|---|---|---|---|
| | content | content | SF | SP | cement | pressure | |
| Mix-design | (%) | (%) | (%) | (%) | ratio (%) | (kPa) | Remark |
| SV-C40- | 40 | 53.4 | 5.3 | 1.2 | 0.53 | 500 | Tamping |
| SF1¹ | | | | | | | rod used |
| SV-C40- | 40 | 53.4 | 5.3 | 1.2 | 0.53 | 250 | Tamping |
| SF1² | | | | | | | rod used |
| SV-C40- | 40 | 53.4 | 5.3 | 1.2 | 0.53 | 0 | Only |
| SF1³ | | | | | | | tamping |
| | | | | | | | rod used |
| SV-C40- | 40 | 53.4 | 5.3 | 1.2 | 0.70 | 0 | Only |
| SF1⁴ | | | | | | | tamping |
| | | | | | | | rod used |

Water is mixed with SP and SF according to Table 18 to form a wet mixture. The wet mixture is added to a dry mixture of PC and cement materials for three to five minutes to obtain the PCBV mixture. The PCBV mixture is placed in prepared molds in two equal layers. Each layer is compacted using a tamping road for around 25 blows. This tamping ensures the proper compaction and densification of the mixes in the molds.

Following the pressing stage, the PCBV mixture is cured within the mold for one day to form the PCBV. After one day, the PCBV is demolded from the steel mold. The demolded PCBV is then placed in the humidifying chamber for further curing. This humidifying chamber provides an amount of moisture, along with other conditions, for the PCBV to cure continuously for 28 days.

The PCBVs are further processed to make the PCBV appear to be natural stone. In one embodiment, the molds are made with stone-like patterns, such as commercial plastic stone veneer molds. The bottom thin plate having stone-like grooves is cut out from the commercial plastic molds. The cut piece was then placed over the rectangular and square-shaped metal molds, and the design mix was then applied to replicate stone-like patterns, ensuring a close semblance to natural stones.

In other embodiments, the fully cured PCBVs are chipped from the sides to give an irregular and uneven pattern on the surface. For chipping, the hammer with a flat-headed chisel may be employed.

Table 19 shows a summary of the compressive strength testing results of the PCBV samples. Compressive strength measures the ability of PCBVs to resist compressive load. The PCBV samples were placed under a compressive strength and loaded to failure. The desired strength for stone veneers as per ASTM C1670 standard is 15 MPa.

TABLE 19
Summary of the Compressive Strength
Testing Results of PCBV Samples.

| | Compressive strength (MPa) | |
|---|---|---|
| Mix-design | 7-day | 28-day |
| SV-C40-SF1¹ | 4.85 | N/A |
| SV-C40-SF1² | 6.95 | 8.45 |
| SV-C40-SF1³ | 7.16 | 16.35 |
| SV-C40-SF1⁴ | 14.67 | 19.20 |
| SV-C40-SF1^{4R} | N/A | 27.81 |

The SV-C40-SF11 samples and SV-C40-SF12 samples did not exhibit the required average compressive strength of 15 MPa when tested after 28 days. However, the SV-C40-SF1³ PCBV sample and SV-C40-SF1⁴ sample exhibited a compressive strength of 16.35 MPa and 19.20 MPa, respectively. Both SV-C40-SF1³ and SV-C40-SF1⁴ PCBV samples met the required compressive strength of 15 MPa per ASTM C1670. Five additional SV-C40-SF1⁴ PCBV samples of size 100 mm×200 mm tested to confirm the initial results. These new samples (SV-C40-SF1^{4R}) had a 28-day compressive strength of 27.81 MPa.

The freeze-thaw test was performed to test the PCBV samples ability to resist crack formation due to cold weather conditions. The PCBV samples have an average dimension of 400×78× 76 mm. The freeze-thaw cycles were carried out in a cabinet which simulates the conditions of cold environmental weather and warm environmental weather conditions. The cabinet was set to alternate between-17 degrees Celsius (freezing condition) and 4.44 degrees Celsius (thawing condition) for five hours. In a day, five test cycles were carried out and the SV-C40-SF1⁴ samples showed the minimum freeze-thaw durability of 50 cycles.

Table 20 shows a summary of the results of a linear dry shrinkage test for PCBV samples. The linear dry shrinkage test measures the linear dimensional stability of PCBV samples. The PCBV samples are prepared using size 51×51×254 mm molds and measured using a digital length Comparator of effective length 254 mm. The PCBV samples had an average linear change of about 0.0066%, which is lower than the permissible range of 0.1% as indicated by ASTM C157.

TABLE 20
Summary of the Results of a Linear Dry Shrinkage Test for PCBV Samples.

| | Comparator reading (in) | | Percent length change |
|---|---|---|---|
| S.N. | After 7 days | After 28 days | After 28 days |
| 1 | 0.0357 | 0.0364 | 0.007% |
| 2 | 0.0227 | 0.0232 | 0.005% |
| 3 | 0.0289 | 0.0297 | 0.008% |

A shear bond test measures the bond strength between the PCBV samples and the substrate upon which it is laid, as well as the structural integrity of the bonds. The average required bond strength is 0.35 MPa. Three SV-C40-SF1⁴ samples are prepared and cured for 28 days. Following 28 days, the SV-C40-SF1⁴ samples are taken out of the curing chamber. A mortar block is prepared based on a cement, sand, and water having a ratio of 1:3.3:0.5 and dimensions 152×114×51 mm. The PCBV samples disposed over the mortar block for one hour with cement paste, where the water-to-cement ratio is maintained as 0.36. The cement paste cures for 7 days.

Table 21 is a summary of the bond shear strength of the PCBV samples. The 7-day shear bond strength for the treated sample is 0.75 MPa, which is above the requirement of 0.35 MPa. This may indicate the reliability of PCBVs in stone veneer application. In some embodiments, commercial bonding materials such as Latpoxy stone adhesive and Baucer polymer cement may be used to improve the bond shear strength. The bond shear strength for PCBV samples using Latpoxy stone adhesive (CbL) is 2.82 MPa and using Baucer polymer cement (CbB) is 2.73 MPa.

TABLE 21
Summary of Bond Shear Strength of the PCBV Samples.

| | | Avg. | Avg. | Avg. | | |
|---|---|---|---|---|---|---|
| | | length | breadth | thickness | Bond strength | |
| Adhesive type | S.N. | (mm) | (mm) | (mm) | (MPa) | |
| Cement paste | 1 | 100 | 100 | 32 | 3.16 | Avg. = |
| | 2 | | | | 2.84 | 0.75 |
| | 3 | | | | 2.85 | |
| Latpoxy stone | 1 | 100 | 100 | 30 | 2.26 | Avg. = |
| adhesive | 2 | | | | 3.37 | 2.82 |
| Baucer polymer | 1 | 100 | 100 | 18 | 3.24 | Avg. = |
| cement | 2 | | | | 2.22 | 2.73 |

In summation, PCBVs utilizing PC gives the desired mechanical properties of a stone veneer. The raw materials include PC and cement materials, to which SP and SF are added as additives to improve the physical and chemical performance of the design mixes. The SV-C40-SF1⁴ had a 28-day average compressive strength of 19.2 MPa, which is greater than the required average compressive strength of 15 MPa. Moreover, the SV-C40-SF1⁴ satisfied the requirements of ASTM C1670.

### EMBODIMENTS LISTING

Clause 1. A pyrolysis char brick (PCB), including:
a composition, the composition comprising:
   a dry mixture, comprising
      pyrolysis char (PC); and
      cement materials; and
   a wet mixture, comprising:
      water;
      silica fume (SF); and
      additives;
   wherein the composition is about 20% to about 40% of PC, about 20% to about 60% cement materials, about 0.1% to about 10% SF, and about 1% to about 1.5% additives, by weight.
Clause 2. The PCB of clause 1, wherein the composition has a water to PC ratio (w/c) of about 0.5 to about 1.5.
Clause 3. The PCB of clause 1, wherein the cement materials and SF form a binder, and wherein the composition has a PC to binder ratio of about 0.3 to about 0.5.
Clause 4. The PCB of clause 1, wherein the PCB has a compressive strength of about 35 MPA to about 55 MPa.
Clause 5. The PCB of clause 1, wherein the PCB has a density of about 1.0 g/cm³ to about 2.0 g/cm³.
Clause 6. The PCB of clause 1, wherein the PCB has a water absorption percentage of less than about 5%.
Clause 7. The PCB of clause 1, wherein the PCB has a saturation coefficient from about 0.4 to about 1.6.
Clause 8. The PCB of clause 1, wherein SF comprises amorphous micronized white silicon dioxide pozzolan, a densified SF, or an undensified SF.
Clause 9. The PCB of clause 1, wherein the additives include a superplasticizer (SP), the SP includes polycarboxylic ether polymer, a polycarboxylate ether, a sulfonated naphthalene formaldehyde, a sulfonated melamine formaldehyde, a lignosulfate, an acrylic polymer, or combinations thereof.
Clause 10. The PCB of clause 1, wherein the additives include an air entraining (AE) agent, the AE agent includes acrylic cement modifiers, natural wood resins, vinsol resins, synthetic detergents, animal and vegetable fats and oils, water-soluble synthetic organic compounds, alkyl benzene sulfonates, or a combination thereof.
Clause 11. The PCB of clause 1, wherein the cement materials comprise ordinary Portland Cement Type I, ordinary Portland Cement Type II, or a combination thereof.
Clause 12. The PCB of clause 1, wherein the PC may include about 75% to about 85% fixed carbon, about 10% to about 20% ash, about 1% to about 3% moisture, and about 0.5% to about 1.5% volatile matter.
Clause 13. The PCB of clause 1, wherein the PC may be pyrolyzed at between about 800° C. and about 900° C.
Clause 14. A pyrolysis char pave block (PCBP), comprising:
a composition, the composition comprising:
   a dry mixture, comprising
      pyrolysis char (PC); and
      cement materials; and
   a wet mixture, comprising:
      water;
      silica fume (SF); and
      additives;
   wherein the composition is about 25% to about 35% of PC, about 20% to about 60% cement materials, about 0.1% to about 10% SF, and about 1% to about 1.5% additives, by weight.
Clause 15. The PCBP of clause 14, wherein the composition has a water to PC ratio (w/c) of about 0.5 to about 1.5.
Clause 16. The PCBP of clause 14, wherein the cement materials and SF form a binder, and wherein the composition has a PC to binder ratio of about 0.3 to about 0.5.
Clause 17. The PCBP of clause 14, wherein the PCBP has a compressive strength of about 50 MPa to about 60 MPa.
Clause 18. The PCBP of clause 14, wherein the PCBP has a water absorption of about 4% to about 6%.
Clause 19. The PCBP of clause 14, wherein the PCBPs have an average mass gain of about 1% to about 5% after the freeze thaw test.
Clause 20. The PCBP of clause 14, wherein the PCBPs have an abrasion value of about 2 mm to about 3 mm.
Clause 21. The PCBP of clause 14, wherein the PCBPs have an abraded volume was about 9 cm³ to about 13 cm³.
Clause 22. The PCBP of clause 14, wherein SF comprises amorphous micronized white silicon dioxide pozzolan, a densified SF, or an undensified SF.
Clause 23. The PCBP of clause 14, wherein the additives include a superplasticizer (SP), the SP includes polycarboxylic ether polymer, a polycarboxylate ether, a sulfonated naphthalene formaldehyde, a sulfonated melamine formaldehyde, a lignosulfate, an acrylic polymer, or combinations thereof.
Clause 24. The PCB of clause 14, wherein the additives include an air entraining (AE) agent, the AE agent includes acrylic cement modifiers, natural wood resins, vinsol resins, synthetic detergents, animal and vegetable fats and oils, water-soluble synthetic organic compounds, alkyl benzene sulfonates, or a combination thereof.
Clause 25. The PCBP of clause 14, wherein the cement materials comprise ordinary Portland Cement Type I, ordinary Portland Cement Type II, or a combination thereof.
Clause 26. The PCBP of clause 14, wherein the PC may include about 75% to about 85% fixed carbon, about 10% to about 20% ash, about 1% to about 3% moisture, and about 0.5% to about 1.5% volatile matter.
Clause 27. The PCBP of clause 14, wherein the PC may be pyrolyzed at between about 800° C. and about 900° C.
Clause 28. A method of forming a composition, the method comprising:
mixing water and additives to form a wet mixture;
mixing pyrolysis char (PC) and cement materials to form a dry mixture;
mixing the wet mixture and the dry mixture to form a pyrolysis char brick (PCB) mixture;
transferring the PCB mixture to a mold;
pre-pressing the PCB mixture;
initially curing the PCB mixture to for a PCB;
demolding the PCB; and
curing the PCB.
Clause 29. The method of clause 28, further comprising drying the PCBs in an oven.
Clause 30. The method of clause 28, further comprising coating the PCBs in a hydrophobic coating liquid.
Clause 31. The method of clause 28, wherein the composition is about 20% to about 40% of PC, about 20% to about 60% cement materials, about 0.1% to about 10% SF, and about 1% to about 1.5% additives, by weight.
Clause 32. The method of clause 28, wherein the composition has a water to PC ratio (w/c) of about 0.5 to about 1.5.
Clause 33. The method of clause 28, wherein the water and additive are mixed for about 1 minute to about 10 minutes.
Clause 34. The method of clause 28, wherein the PC and cement materials are mixed for about 1 minute to about 5 minutes.
Clause 35. The method of clause 28, wherein the additives include air entraining (AE) agents and superplastisizers (SP).
Clause 36. The method of claim 35, wherein the AE agent includes acrylic cement modifiers, natural wood resins, vinsol resins, synthetic detergents, animal and vegetable fats and oils, water-soluble synthetic organic compounds, alkyl benzene sulfonates, or a combination thereof.
Clause 37. The method of claim 35, wherein the SP includes polycarboxylic ether polymer, a polycarboxylate ether, a sulfonated naphthalene formaldehyde, a sulfonated melamine formaldehyde, a lignosulfate, an acrylic polymer, or combinations thereof.
Clause 38. The method of clause 28, wherein the cement materials and SF form a binder, and wherein the composition has a PC to binder ratio of about 0.3 to about 0.5.
Clause 39. The method of clause 28, wherein the wet mixture and the dry mixture are mixed for about 1 minute to about 10 minutes.
Clause 40. The method of clause 28, wherein the pre-pressing has a pressing pressure of about 4 MPa to about 10 MPa.
Clause 41. The method of clause 28, wherein the pre-pressing has a pressing time of about 30 seconds to about 3 minutes.
Clause 42. The method of clause 28, wherein the temperature of the initial curing is about 20° C. to about 30° C.
Clause 43. The method of clause 28, wherein the humidity of the initial curing is about 90% to about 100%.
Clause 44. The method of clause 28, wherein the initial curing is about 5 to about 30 days.
Clause 45. The method of clause 28, wherein the PCB is cured in a wet room at a temperature of 24° C. and relative humidity of 95%.
Clause 46. The method of clause 28, wherein the PCB is cured for about 5 days to about 30 days.
Clause 47. The method of clause 28, further comprising air-drying the PCB at a temperature of about 50° C. to about 70° C.
Clause 48. The method of clause 47, wherein the PCB is air-dried for about 20 hours to about 30 hours.
Clause 49. The method of clause 28, wherein the hydrophobic coating includes a styrene acrylate material.
Clause 50. The method of clause 28-49, wherein the additive includes trass and trass lime.
Clause 51. The method of clause 28-49, wherein the additives include fly ash and alkaline activators.
Clause 52. The PCBP of clause 14-27, wherein the additive includes trass and trass lime.
Clause 51. The PCBP of clause 14-27, wherein the additives include fly ash and alkaline activators.
Clause 52. A pyrolysis char brick veneer (PCBV), comprising:
a composition, the composition comprising:
   a dry mixture, comprising
      pyrolysis char (PC); and
      cement materials; and
   a wet mixture, comprising:
      water;
      silica fume (SF); and
      additives;
   wherein the composition is about 25% to about 40% of PC, about 20% to about 60% cement materials, about 0.1% to about 10% SF, and about 1% to about 1.5% additives, by weight.
Clause 53. The PCBV of clause 52, wherein the composition has a water to PC ratio (w/c) of about 0.5 to about 1.5.
Clause 54. The PCBV of clause 52, wherein the cement materials and SF form a binder, and wherein the composition has a PC to binder ratio of about 0.3 to about 0.5.
Clause 55. The PCBV of clause 52, wherein the PCBV has a compressive strength of about 15 MPa to about 30 MPa.
Clause 56. The PCBV of clause 52, wherein the PCBV has a water absorption of about 4% to about 6%.
Clause 57. The PCBV of clause 52, wherein the PCBVs have an average mass gain of about 1% to about 5% after the freeze thaw test.
Clause 58. The PCBV of clause 52, wherein the PCBVs have an abrasion value of about 2 mm to about 3 mm.
Clause 59. The PCBV of clause 52, wherein the PCBVs have an abraded volume was about 9 cm³ to about 13 cm³.
Clause 60. The PCBV of clause 52, wherein SF comprises amorphous micronized white silicon dioxide pozzolan, a densified SF, or an undensified SF.
Clause 61. The PCBV of clause 52, wherein the additives include a superplasticizer (SP), the SP includes polycarboxylic ether polymer, a polycarboxylate ether, a sulfonated naphthalene formaldehyde, a sulfonated melamine formaldehyde, a lignosulfate, an acrylic polymer, or combinations thereof.
Clause 62. The PCBV of clause 52, wherein the additives include an air entraining (AE) agent, the AE agent includes acrylic cement modifiers, natural wood resins, vinsol resins, synthetic detergents, animal and vegetable fats and oils, water-soluble synthetic organic compounds, alkyl benzene sulfonates, or a combination thereof.
Clause 63. The PCBV of clause 52, wherein the cement materials comprise ordinary Portland Cement Type I, ordinary Portland Cement Type II, or a combination thereof.
Clause 64. The PCBV of clause 52, wherein the PC may include about 75% to about 85% fixed carbon, about 10% to about 20% ash, about 1% to about 3% moisture, and about 0.5% to about 1.5% volatile matter.
Clause 65. The PCBV of clause 52, wherein the PC may be pyrolyzed at between about 800° C. and about 900° C.
Clause 66. The PCBV of clause 52, wherein the PCBV has a 7-day curing compression strength of greater than 7 MPa.
Clause 67. The PCBV of clause 52, wherein the PCBV has a 28-day curing compression strength of greater than 15 MPa.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, process operation, process operations, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, process operation, process operations, element, or elements and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

While the foregoing is directed to embodiments of the present disclosure, other and further embodiments of the disclosure may be devised without departing from the basic scope thereof.

What is claimed is:

1. A pyrolysis char brick veneer (PCBV), comprising:
a composition, the composition comprising:
a dry mixture, comprising
pyrolysis char (PC); and
cement materials; and
a wet mixture, comprising:
water;
silica fume (SF); and
additives;
wherein the composition is about 20% to about 40% of PC, about 20% to about 60% cement materials, about 0.1% to about 10% SF, and about 1% to about 1.5% additives, by weight.

2. The PCBV of claim 1, wherein the PCBV has an average linear change of about 0.0066%.

3. The PCBV of claim 1, wherein the PCBV has a bond shear strength of about 2 MPa to about 4 MPa.

4. The PCBV of claim 1, wherein the PCBV has a 28-day curing compressive strength of greater than about 15 MPa.

5. The PCBV of claim 1, wherein the PCBV has a density of about 1.0 g/cm³ to about 2.0 g/cm³.

6. A pyrolysis char pave block (PCBP), comprising:
a composition, the composition comprising:
a dry mixture, comprising
pyrolysis char (PC); and
cement materials; and
a wet mixture, comprising:
water;
silica fume (SF); and
additives;
wherein the composition is about 25% to about 35% of PC, about 20% to about 60% cement materials, about 0.1% to about 10% SF, and about 1% to about 1.5% additives, by weight.

7. The PCBP of claim 6, wherein the composition has a water to PC ratio (w/c) of about 0.5 to about 1.5.

8. The PCBP of claim 6, wherein the additive comprises trass, trass lime, fly ash, alkaline activators, or a combination thereof.

9. The PCBP of claim 8, wherein the PCBP has a compressive strength of about 50 MPa to about 60 MPa.

10. The PCBP of claim 6, wherein the PCBP has a water absorption of about 4% to about 6.

11. A method of forming a composition, the method comprising:
mixing water and additives to form a wet mixture;
mixing pyrolysis char (PC) and cement materials to form a dry mixture;
mixing the wet mixture and the dry mixture to form a pyrolysis char brick veneer (PCBV) mixture;
transferring the PCBV mixture to a mold;
pre-pressing the PCBV mixture;
initially curing the PCBV mixture to for a PCBV;
demolding the PCBV; and
curing the PCBV.

12. The method of claim 11, further comprising drying the PCBVs in an oven.

13. The method of claim 11, further comprising coating the PCBVs in a hydrophobic coating liquid.

14. The method of claim 11, wherein the composition is about 20% to about 40% of PC, about 20% to about 60% cement materials, about 0.1% to about 10% SF, and about 1% to about 1.5% additives, by weight.

15. The method of claim 11, wherein the composition has a water to PC ratio (w/c) of about 0.5 to about 1.5.
